(19) United States
(12) Patent Application Publication
(10) Pub. No.: US 2024/0105213 A1
(43) Pub. Date: Mar. 28, 2024

(54) SIGNAL ENERGY CALCULATION WITH A NEW METHOD AND A SPEECH SIGNAL ENCODER OBTAINED BY MEANS OF THIS METHOD

(71) Applicant: CANKAYA UNIVERSITESI, Ankara (TR)

(72) Inventor: Selma OZAYDIN, Ankara (TR)

(73) Assignee: CANKAYA UNIVERSITESI, Ankara (TR)

(21) Appl. No.: 17/767,953

(22) PCT Filed: Aug. 31, 2020
(86) PCT No.: PCT/TR2020/050787

§ 371 Date: Apr. 11, 2022

(30) Foreign Application Priority Data
Nov. 4, 2019 (TR) 2019/17042

(51) Int. Cl. G10L 25/87; G10L 25/21; G10L 25/45; G10L 25/93

(52) U.S. Cl. CPC G10L 25/87; G10L 25/21; G10L 25/45; G10L 25/93

(57) ABSTRACT

The present invention relates to a signal encoder and a method for encoding signals that allows for encoding signals, calculating energy by means of encoded signals, and detecting speech activity regions in the speech signal over the energy regions of the encoded signal by means of a novel method for encoding signals. The present invention particularly relates to a signal encoder and a method thereof that allows for encoding noisy input signals by means of the proposed method, calculating energy regions of signals encoded by means of a novel method thereby creating an energy signal even in conditions where high noise levels are present and distinguishing voiced regions and unvoiced regions from one another in determining voice activity regions (VAD) of an input speech signal by using the proposed energy calculation.

### TECHNICAL FIELD OF THE INVENTION

The present invention relates to a signal encoder and method that enables the encoding of signals, the calculation of energy with the encoded signals, and determination of the speech activity regions in the speech signal over the energy regions of the encoded signal by means of a new method for encoding signals. The present invention particularly relates to a signal encoder and a method thereof that allows for encoding noisy input signals with the proposed method, calculating energy regions of signals encoded by means of the subject-matter of novel method thereby creating an energy signal even in conditions where high noise levels are present and distinguishing voiced regions and unvoiced regions from one another in determining voice activity regions (VAD) of an input speech signal by using the proposed energy calculation.

### STATE OF THE ART

Conversion from analog to digital must be performed in order to process analog sounds with digital signal processing methods. Various coding methods are available for converting analog sounds to digital.

There are various encoders used for audio encoding and decoding in addition to signal encoding techniques. These encoders can be used for different purposes and particularly for storing high-quality audio more efficiently, storing high-quality audio in reduced sizes, voice broadcasting over the Internet, and providing audio communication in networks of telephone lines. Some of the active methods involve μ-law and A-law techniques.

The μ-law method is an established standard used for encoding 8-bit PCM (pulse code modulation) signals in telecommunication systems. Said method is an efficient technique for reducing the dynamic range of the speech signal by encoding the speech signal. However, it has been observed that the usage of this method in digital systems increases the ratio of signal-noise (SNR-signal/noise ratio) during the quantization of the signal. This simple encoding/compression method allows for compressing a 13-bit speech signal to an 8-bit signal over the communication channel. However, this method brings along certain issues and fails to solve some specific problems.

The patent file numbered 2018/11073 was examined as a result of the preliminary research conducted in the state of the art. Abstract of said invention discloses “in an encoding method that is expected to generate a smaller amount of code between a periodicity based encoding method and a non-periodicity-based encoding method, the code amount of an integer value or an estimated value of the code amount is obtained during the adjustment of the gain. In the other encoding method, an integer value sequence obtained in this process is substituted to obtain the amount of code or estimated value of the code amount of the integer value sequence. The obtained code amounts or estimated values are compared to select one of the encoding methods, and the integer value sequence is encoded using the selected encoding method to obtain and output an integer signal code”.

The patent document numbered “US20170133041” was examined as a result of the preliminary search conducted in the state of the art. The invention disclosed in said patent document relates to a voice activity detector. The voice activity detection method disclosed in said patent document is based on first and second formant frequencies in the speech signal. It is an analysis method implemented in the frequency domain. Therefore, the computational complexity of the system is high. Moreover, the detector disclosed in said patent application operates by using audio signals received from two channels.

The patent document numbered “US20120173234A1” was examined as a result of the preliminary search conducted in the state of the art. The invention disclosed in said patent document relates to an acoustic signal analyzer that improves the processing efficiency and estimation accuracy of a voice activity detection apparatus. The method utilized in the afore-mentioned invention involves calculating GMM (Gaussian Mixture Method) probability parameters from the received speech signal and channel noise signal, calculating density functions for both GMMs and comparing them thereafter. Calculating GMM parameters from the speech signal is a method with high computational complexity and performing respective analyses for both speech signal and noise signal in each audio window increases the computational complexity even further. Furthermore, the afore-mentioned patent application does not disclose anything with regards to a calculation based on energy estimation and on time-domain analysis.

The patent document numbered “U.S. Pat. No. 5,867,574A” was examined as a result of the preliminary search conducted in the state of the art. The invention disclosed in said patent application relates to a voice activity detection system and method. Said invention utilizes an energy calculation method based on an integral of the absolute value of a derivative of a speech signal. The sum of amplitude differences of the input signal is used for the prediction of voice activity regions.

The patent document numbered “US20010016811A1” was examined as a result of the preliminary search conducted in the state of the art. The invention disclosed in the afore-mentioned patent application relates to a speech coding system comprising an encoder and a decoder having multi-rate speech codecs. Said invention proposes inserting a voice activity region method into a channel coding algorithm to detect non-speech regions in encoding a speech signal over a channel. The aforementioned invention is a method for detecting non-speech regions by means of voice activity region block proposed to be inserted into the channel coding structure, thereby enabling the efficient use of the channel and reducing the number of bits transmitted over the channel.

In the state of the art, for calculating energy amplitude values of an input signal, energy amplitude values for noise-free audio signals yield better results when the energy of a speech signal transformed by means of the RMS method that is based on time-domain analysis is calculated or when the energy of a speech signal transformed by square amplitude method is calculated. However, energy amplitude values drop rapidly when the energy of signals transformed with the RMS method or square amplitude method is calculated for audio signals with noise. This makes it difficult to detect voice activity zones.

Again, the energy amplitude values yield satisfactory results when the energy is calculated with the speech signal transformed by means of the μ-law technique for noise-free audio signals. When the energy of signal converted by means of μ-law is calculated, though the energy amplitude value yields better results for audio signals with noise compared to calculated energy amplitude values, it drops rapidly as the amount of noise increases. Accordingly, detecting voice activity regions with high accuracy by obtaining energy amplitude values based on the aforementioned technique becomes difficult for signals having high noise levels.

In order to detect voice activity regions, several studies have been carried out in the time domain or the frequency domain with various methods utilized in the state of the art. These methods, however, have difficulties in separating the noise and the signal from one another when there is a base noise, and for detection, the respective decision is made by examining previous and future analysis windows. In order to make an energy-based analysis with these methods, either the maximum energy of the signal should be calculated or the threshold value at the distinction of voiced/unvoiced window in every new analysis window should be updated. All these make it difficult to provide real-time analysis based on energy calculations.

Consequently, the disadvantages disclosed above and the inadequacy of available solutions in this regard necessitated making an improvement in the relevant technical field.

### OBJECTS OF THE INVENTION

The most important object of the present invention is to preserve average signal energy amplitude levels for input signals with noise by means of a factor ‘k’ proposed to be integrated into the signal energy calculation, thereby increasing the rate of detection accuracy for voice activity (voiced/unvoiced) regions. Another object of the present invention is to perform a non-linear energy calculation for separating voiced/unvoiced regions of a speech signal by means of the voice activity region (VAD) algorithm. Thus, the energy of low-amplitude signals is increased and calculated accordingly for noise-free sounds, while the energy of signals with higher amplitude is suppressed and the energy regions of all speech signals are detected with high accuracy. On the other hand, the energy of signals that are close to the base noise level is suppressed and the energy of signals with high amplitude is increased. The process of suppressing and increasing the energy according to the noise is carried out by considering the base noise level.

Another object of the present invention is to perform energy calculation by using only the signal in the analysis window. Thus, only the energy value is determined, and voiced/unvoiced regions of the signal are distinguished from one another in real-time.

Yet another object of the present invention is to ensure that it may be used for setting forth the energy regions of signals containing many different types of noise in digital signal processing by means of its high-performing structure against signals with noise.

Yet another object of the present invention is to ensure that it utilizes a method based on energy calculation and time-domain analysis. Thus, it is based on a real-time analysis carried out by means of a novel energy method calculated from the speech signal present in every analysis window in the time domain instead of frequency domain analysis methods or non-real-time analysis methods that require complex calculations.

Yet another object of the present invention is to ensure that no signal filtering is used for noise resistance. Thus, even though no signal filtering operation is performed, voiced/unvoiced regions of an input signal and correspondingly the voice activity regions are detected with a high accuracy rate even in cases where the input signal contains high levels of noise.

Yet another object of the present invention is to determine the noise THRESHOLD signal at the rate of base noise in order to increase the energy gain value in noisy audio signals. For this, value k in which the energy amplitude levels may be preserved was searched by gradually adding the Gaussian noise signal to the clean input signal.

The structural and characteristic features of the present invention and all advantages thereof will be understood more clearly through the accompanying figures which are described below and by means of the detailed description written by making references to these figures. Therefore, the respective evaluation should be conducted by taking these figures and the detailed description into consideration.

### DESCRIPTION OF THE FIGURES

FIG. 1 is an illustration of the block diagram of the speech signal encoding operation of the encoder subject to the invention.

FIG. 2 is an illustration of the block diagram of energy calculation (Equation 12) for the speech signal in the analysis window of the encoder subject to the invention.

FIG. 3 is an illustration of the encoder function variation interval chart for different μ values plotted by selecting k=1 as a result of the experiment conducted with the encoder subject to the invention.

FIG. 4 is an illustration of the variation interval chart plotted for different k values and selected μ value (μ=1) as a result of the experiment conducted with the encoder subject to the invention.

FIG. 5 is an illustration of the variation interval chart plotted for different k values and selected μ value (μ=10) as a result of the experiment conducted with the encoder subject to the invention.

FIG. 6 is an illustration of the variation interval chart plotted for different k values and selected μ value (μ=50) as a result of the experiment conducted with the encoder subject to the invention.

FIG. 7 is an illustration of the variation interval chart plotted for different k values and selected μ value (μ=100) as a result of the experiment conducted with the encoder subject to the invention.

FIG. 8 is an illustration of the variation interval chart plotted for different k values and selected μ value (μ=150) as a result of the experiment conducted with the encoder subject to the invention.

FIG. 9 is an illustration of the variation interval chart plotted for different k values and selected μ value (μ=200) as a result of the experiment conducted with the encoder subject to the invention.

FIG. 10 is an illustration of the variation interval chart plotted for different k values and selected μ value (μ=250) as a result of the experiment conducted with the encoder subject to the invention.

FIG. 11 is an illustration of the variation interval chart plotted for different k values and selected μ value (μ=500) as a result of the experiment conducted with the encoder subject to the invention.

FIG. 12 is an illustration of the variation interval chart plotted for different k values and selected μ value (μ=1000) as a result of the experiment conducted with the encoder subject to the invention.

FIG. 13 is an illustration of the encoder function variation interval chart plotted for different μ value (μ=10000) as a result of the experiment conducted with the encoder subject to the invention.

FIG. 14 is an illustration of the variation interval chart plotted for different k values and selected μ value (μ=100000) as a result of the experiment conducted with the encoder subject to the invention.

FIG. 15 is an illustration of the energy charts plotted for Clean audio signal and noisy audio signal as a result of the experiment conducted with Mulaw energy calculation (Equation 11). (equal clean and noisy audio)

FIG. 16 is an illustration of the energy charts plotted for the clean audio signal and noisy audio signal as a result of the experiment conducted with the encoder subject to the invention (Equation 12). (equal clean and noisy audio)

FIG. 17 is an illustration of the energy charts plotted for the clean audio signal and noisy audio signal as a result of the experiment conducted with the square amplitude energy calculation (Equation 10). (equal clean and noisy audio)

FIG. 18 is an illustration of the energy charts plotted for a clean audio signal and noisy audio signal as a result of the experiment conducted with the RMS energy calculation (Equation 8). (equal clean and noisy audio)

FIG. 19 is an illustration of the energy charts plotted for the clean audio signal and noisy audio signal as a result of the experiment conducted with Mulaw energy calculation (Equation 11). (for the noisy audio at the level of SNR˜16 dB)

FIG. 20 is an illustration of the energy charts plotted for a clean audio signal and noisy audio signal as a result of the experiment conducted with the encoder subject to the invention (Equation 12). (for the noisy audio at the level of SNR˜16 dB)

FIG. 21 is an illustration of the energy charts plotted for the clean audio signal and noisy audio signal as a result of the experiment conducted with square amplitude energy calculation (Equation 10). (for the noisy audio at the level of SNR˜16 dB)

FIG. 22 is an illustration of the energy charts plotted for the clean audio signal and noisy audio signal as a result of the experiment conducted with RMS energy calculation (Equation 8). (for the noisy audio at the level of SNR˜16 dB)

FIG. 23 is an illustration of the energy charts plotted for the clean audio signal and noisy audio signal as a result of the experiment conducted with Mulaw energy calculation (Equation 11). (for the noisy audio at the level of SNR˜6 dB)

FIG. 24 is an illustration of the energy charts plotted for a clean audio signal and noisy audio signal as a result of the experiment conducted with the encoder subject to the invention (Equation 12). (for the noisy audio at the level of SNR˜6 dB)

FIG. 25 is an illustration of the energy charts plotted for the clean audio signal and noisy audio signal as a result of the experiment conducted with square amplitude energy calculation (Equation 10). (for the noisy audio at the level of SNR˜6 dB)

FIG. 26 is an illustration of the energy charts plotted for the clean audio signal and noisy audio signal as a result of the experiment conducted with RMS energy calculation (Equation 8). (for the noisy audio at the level of SNR˜6 dB)

FIG. 27 is an illustration of the energy charts plotted for the clean audio signal and noisy audio signal as a result of the experiment conducted with Mulaw energy calculation (Equation 11). (for noisy audio at the level of SNR˜−4 dB)

FIG. 28 is an illustration of the energy charts plotted for a clean audio signal and noisy audio signal as a result of the experiment conducted with the encoder subject to the invention (Equation 12). (for noisy audio at the level of SNR˜−4 dB)

FIG. 29 is an illustration of the energy charts plotted for the clean audio signal and noisy audio signal as a result of the experiment conducted with square amplitude energy calculation (Equation 10). (for noisy audio at the level of SNR˜−4 dB)

FIG. 30 is an illustration of the energy charts plotted for the clean audio signal and noisy audio signal as a result of the experiment conducted with RMS energy calculation (Equation 8). (for noisy audio at the level of SNR˜−4 dB)

FIG. 31 is an illustration of the energy charts plotted for the clean audio signal and noisy audio signal as a result of the experiment conducted with Mulaw energy calculation (Equation 11). (for noisy audio at the level of SNR˜−4 dB)

FIG. 32 is an illustration of the energy charts plotted for a clean audio signal and noisy audio signal as a result of the experiment conducted with the encoder subject to the invention (Equation 12). (for noisy audio at the level of SNR˜−9 dB)

FIG. 33 is an illustration of the energy charts plotted for the clean audio signal and noisy audio signal as a result of the experiment conducted with square amplitude energy calculation (Equation 10). (for noisy audio at the level of SNR˜−9 dB)

FIG. 34 is an illustration of the energy charts plotted for the clean audio signal and noisy audio signal as a result of the experiment conducted with RMS energy calculation (Equation 8). (for noisy audio at the level of SNR˜−9 dB)

FIG. 35 is an illustration of the energy charts plotted for the clean audio signal and noisy audio signal as a result of the experiment conducted with Mulaw energy calculation (Equation 11). (for noisy audio at the level of SNR˜−14 dB)

FIG. 36 is an illustration of the energy charts plotted for a clean audio signal and noisy audio signal as a result of the experiment conducted with the encoder subject to the invention (Equation 12). (for noisy audio at the level of SNR˜−14 dB)

FIG. 37 is an illustration of the energy charts plotted for the clean audio signal and noisy audio signal as a result of the experiment conducted with square amplitude energy calculation (Equation 10). (for noisy audio at the level of SNR˜−14 dB)

FIG. 38 is an illustration of the energy charts plotted for the clean audio signal and noisy audio signal as a result of the experiment conducted with RMS energy calculation (Equation 8). (for noisy audio at the level of SNR˜−14 dB)

FIG. 39 is an illustration of the charts of Voiced/Unvoiced (VAD) (Voiced/Unvoiced—VUV) decision regions for clean and noisy speech signals as a result of the experiment conducted with Mulaw energy calculation (Equation 11). (equal clean and noisy audio)

FIG. 40 is an illustration of the charts of Voiced/Unvoiced (VAD) (Voiced/Unvoiced—VUV) decision regions for clean and noisy speech signals as a result of the experiment conducted with the encoder subject to the invention (Equation 12). (equal clean and noisy audio)

FIG. 41 is an illustration of the charts of Voiced/Unvoiced (VAD) (Voiced/Unvoiced—VUV) decision regions for clean and noisy speech signals as a result of the experiment conducted with square amplitude energy calculation (Equation 10). (equal clean and noisy audio)

FIG. 42 is an illustration of the charts of Voiced/Unvoiced (VAD) (Voiced/Unvoiced—VUV) decision regions for clean and noisy speech signals as a result of the experiment conducted with RMS energy calculation (Equation 8). (equal clean and noisy audio)

FIG. 43 is an illustration of the charts of Voiced/Unvoiced (VAD) (Voiced/Unvoiced—VUV) decision regions for clean and noisy speech signals as a result of the experiment conducted with Mulaw energy calculation (Equation 11). (for the noisy audio at the level of SNR˜16 dB)

FIG. 44 is an illustration of the charts of Voiced/Unvoiced (VAD) (Voiced/Unvoiced—VUV) decision regions for clean and noisy speech signals as a result of the experiment conducted with the encoder subject to the invention (Equation 12). (for the noisy audio at the level of SNR˜16 dB)

FIG. 45 is an illustration of the charts of the Voiced/Unvoiced (VAD) (Voiced/Unvoiced—VUV) decision regions for clean and noisy speech signals as a result of the experiment conducted with square amplitude energy calculation (Equation 10). (for the noisy audio at the level of SNR˜16 dB)

FIG. 46 is an illustration of the charts of the Voiced/Unvoiced (VAD) (Voiced/Unvoiced—VUV) decision regions for clean and noisy speech signals as a result of the experiment conducted with the RMS energy calculation (Equation 8). (for the noisy audio at the level of SNR˜16 dB)

FIG. 47 is an illustration of the charts of Voiced/Unvoiced (VAD) (Voiced/Unvoiced—VUV) decision regions for clean and noisy speech signals as a result of the experiment conducted with Mulaw energy calculation (Equation 11). (for the noisy audio at the level of SNR˜6 dB)

FIG. 48 is an illustration of the charts of Voiced/Unvoiced (VAD) (Voiced/Unvoiced—VUV) decision regions for clean and noisy speech signals as a result of the experiment conducted with the encoder subject to the invention (Equation 12). (for the noisy audio at the level of SNR˜6 dB)

FIG. 49 is an illustration of the charts of the Voiced/Unvoiced (VAD) (Voiced/Unvoiced—VUV) decision regions for clean and noisy speech signals as a result of the experiment conducted with square amplitude energy calculation (Equation 10). (for the noisy audio at the level of SNR˜6 dB)

FIG. 50 is an illustration of the charts of the Voiced/Unvoiced (VAD) (Voiced/Unvoiced—VUV) decision regions for clean and noisy speech signals as a result of the experiment conducted with the RMS energy calculation (Equation 8). (for the noisy audio at the level of SNR˜6 dB)

FIG. 51 is an illustration of the charts of Voiced/Unvoiced (VAD) (Voiced/Unvoiced—VUV) decision regions for clean and noisy speech signals as a result of the experiment conducted with Mulaw energy calculation (Equation 11). (for the noisy audio at the level of SNR˜0 dB)

FIG. 52 is an illustration of the charts of Voiced/Unvoiced (VAD) (Voiced/Unvoiced—VUV) decision regions for clean and noisy speech signals as a result of the experiment conducted with the encoder subject to the invention (Equation 12). (for the noisy audio at the level of SNR˜0 dB)

FIG. 53 is an illustration of the charts of the Voiced/Unvoiced (VAD) (Voiced/Unvoiced—VUV) decision regions for clean and noisy speech signals as a result of the experiment conducted with square amplitude energy calculation (Equation 10). (for the noisy audio at the level of SNR˜0 dB)

FIG. 54 is an illustration of the charts of the Voiced/Unvoiced (VAD) (Voiced/Unvoiced—VUV) decision regions for clean and noisy speech signals as a result of the experiment conducted with the RMS energy calculation (Equation 8). (for the noisy audio at the level of SNR˜0 dB)

FIG. 55 is an illustration of the charts of Voiced/Unvoiced (VAD) (Voiced/Unvoiced—VUV) decision regions for clean and noisy speech signals as a result of the experiment conducted with Mulaw energy calculation (Equation 11). (for noisy audio at the level of SNR˜−4 dB)

FIG. 56 is an illustration of the charts of Voiced/Unvoiced (VAD) (Voiced/Unvoiced—VUV) decision regions for clean and noisy speech signals as a result of the experiment conducted with the encoder subject to the invention (Equation 12). (for noisy audio at the level of SNR˜−4 dB)

FIG. 57 is an illustration of the charts of the Voiced/Unvoiced (VAD) (Voiced/Unvoiced—VUV) decision regions for clean and noisy speech signals as a result of the experiment conducted with square amplitude energy calculation (Equation 10). (for noisy audio at the level of SNR˜−4 dB)

FIG. 58 is an illustration of the charts of the Voiced/Unvoiced (VAD) (Voiced/Unvoiced—VUV) decision regions for clean and noisy speech signals as a result of the experiment conducted with the RMS energy calculation (Equation 8). (for noisy audio at the level of SNR˜−4 dB)

FIG. 59 is an illustration of the charts of Voiced/Unvoiced (VAD) (Voiced/Unvoiced—VUV) decision regions for clean and noisy speech signals as a result of the experiment conducted with Mulaw energy calculation (Equation 11). (for noisy audio at the level of SNR˜−9 dB)

FIG. 60 is an illustration of the charts of Voiced/Unvoiced (VAD) (Voiced/Unvoiced—VUV) decision regions for clean and noisy speech signals as a result of the experiment conducted with the encoder subject to the invention (Equation 12). (for noisy audio at the level of SNR˜−9 dB)

FIG. 61 is an illustration of the charts of the Voiced/Unvoiced (VAD) (Voiced/Unvoiced—VUV) decision regions for clean and noisy speech signals as a result of the experiment conducted with square amplitude energy calculation (Equation 10). (for noisy audio at the level of SNR˜−9 dB)

FIG. 62 is an illustration of the charts of the Voiced/Unvoiced (VAD) (Voiced/Unvoiced—VUV) decision regions for clean and noisy speech signals as a result of the experiment conducted with the RMS energy calculation (Equation 8). (for noisy audio at the level of SNR˜−9 dB)

FIG. 63 is an illustration of the charts of Voiced/Unvoiced (VAD) (Voiced/Unvoiced—VUV) decision regions for clean and noisy speech signals as a result of the experiment conducted with Mulaw energy calculation (Equation 11). (for noisy audio at the level of SNR˜−14 dB)

FIG. 64 is an illustration of the charts of Voiced/Unvoiced (VAD) (Voiced/Unvoiced—VUV) decision regions for clean and noisy speech signals as a result of the experiment conducted with the encoder subject to the invention (Equation 12). (for noisy audio at the level of SNR˜−14 dB)

FIG. 65 is an illustration of the charts of the Voiced/Unvoiced (VAD) (Voiced/Unvoiced—VUV) decision regions for clean and noisy speech signals as a result of the experiment conducted with square amplitude energy calculation (Equation 10). (for noisy audio at the level of SNR˜−14 dB)

FIG. 66 is an illustration of the charts of the Voiced/Unvoiced (VAD) (Voiced/Unvoiced—VUV) decision regions for clean and noisy speech signals as a result of the experiment conducted with the RMS energy calculation (Equation 8). (for noisy audio at the level of SNR˜−14 dB)

### REFERENCE NUMERALS

100. Speech Signal
101. Window Divider
102. Value Determiner
103. Energy Average Value Calculator
104. Loop Initiator
105. Analysis Window Energy Calculator
106. Equality Analyzer
107. Voiced Region Determiner
108. Unvoiced Region Determiner
109. Loop Continuator
110. Region Plotter
201. Determining Avgx, μ, x(n) and Eₘᵢₙ values
202. Determining b1, b2, and k_{threshold} values
203. Calculating a value
204. Calculating coefficient k
205. Making equality comparison between coefficient k and k_{threshold} value
206. Equalizing coefficient k to k_{threshold} value if the coefficient k is smaller than k_{trochoid} value
207. Calculating Fw(x(n)) value if the coefficient k is greater than k_{threshold} value
208. Calculating EwS(n) energy value

### DETAILED DESCRIPTION OF THE INVENTION

The subject-matter of encoder allows for performing signal energy calculation by means of a novel method for encoding signals. With the said energy calculation, an algorithm is obtained in which the speech activity regions of the speech signal are determined. In this method, which is used for encoding signals, a novel equation (Equation 2) is developed based on the μ-law method (Equation 1) and respective calculations are performed in the encoder according to said equation. In Equation 1, μ value is used as a compression parameter and determined in a range between (μ: 0-255). Here, x(n) denotes a normalized input audio signal sequence. μ-law signal encoding formula is as follows;

F(x(n))=sgn(x(n))·ln(1+μ·|x(n)|)/ln(1+μ), −1≤x(n)≤1, (1)

And the signal encoding formula of the encoder subject to the invention is;

Fw(x(n))=sgn(x)·ln(1+μ·|x(n)|)/ln(1+k·μ), −1≤x(n)≤1, (2)

The energy amplitude level is preserved by means of Equation 2 (coefficient k) used in the encoder subject to the invention. As a result, the percentage rate for detecting voice activity regions (VAD) increases due to preserving energy regions for a speech signal. The operation carried out herein is amplifying the noisy signal as much as the base noise to increase the energy gain value in noisy audio signals. To that end, value k through which energy amplitude levels are preserved was tried to be determined by gradually adding Gaussian noise signal on the clean input signal. Accordingly, k formula was developed by means of the inventive method. These differences ensure that the present invention differs from the solutions available in the state of the art.

The encoder subject to the invention and the technique used in the method will yield superior results in real-time speech processing. The process steps of the inventive method are outlined below.

The energy threshold value is determined from the selected analysis windows.

The signals in each speech analysis window of speech signals are transformed into a new signal by means of the encoder.

The energy of transformed signals is calculated.

Voiced/unvoiced regions are distinguished by comparing the calculated energy value and the initial threshold value.

The speech starting point is determined if the energy value is greater than the threshold value.

And the speech ending point is determined if the energy value is smaller than the threshold value.

The encoder subject to the invention is used for distinguishing voiced and unvoiced regions in a detection operation carried out for detecting voice activity regions of a speech signal (100). Test results indicate that the energy calculation performed with the encoder subject to the invention and the method yields excellent results even in signals with high noise levels. The Voice activity region (VAD) algorithm designed as a part of the technique used in the encoder subject to the invention performs a non-linear energy calculation in separating voiced/unvoiced regions of the speech signal (100). Thus, the energy of low-amplitude signals is increased and calculated accordingly for noise-free sound, while the energy of signals with higher amplitude is suppressed and the energy regions of all speech signals are tried to be detected. On the other hand, the energy of signals that are close to the base noise level is suppressed and the energy of signals with high amplitude is increased. The operation of suppressing the energy based on the noise and amplifying it accordingly is carried out by considering the base noise level.

Certain components form the basis of the operation involving detecting the voice active regions of the speech signal (100) carried out by means of the encoder subject to the invention. These components are; window divider (101), value determiner (102), energy average value calculator (103), loop initiator (104), analysis window energy calculator (105), equality analyzer (106), voiced region determiner (107), unvoiced region determiner (108), loop continuator (109) and region plotter (110).

Window divider (101) divides the speech signal (100) into analysis windows, wherein the speech signal is obtained by using only the total value of amplitude squares in an energy calculation with a normal distribution.

Value determiner (102) determines the initial values of unvoiced region analysis windows selected in the beginning.

The energy average value calculator (103), calculates the average value of energy in the unvoiced signal window range selected in the beginning. These average values are; Eₘᵢₙ, average signal noise amplitude value (Avgx), unvoiced region maximum energy threshold value (Thre) and input signal energy threshold value (Esikdgr), and these values are calculated by the energy average value calculator (103) by using the equations of the inventive method. Eₘᵢₙ is calculated through Equation 6, average signal noise amplitude value (Avgx) is calculated through Equation 4 and Equation 5, the energy threshold value (Thre) is calculated through Equation 7 and (Esikdgr) is calculated through Equation 13. (In Equation 13, experimental studies were carried out by selecting c=10).

Loop initiator (104) initiates the calculation of the speech signal (100) obtained by means of the equations used by the energy average value calculator (103).

Analysis window energy calculator (105) ensures that EwS(n) energy values are calculated by obtaining the sum of squares of transformed values (Equation 2) of speech signals (100). EwS(n) is calculated by using Equation 12.

Equality analyzer (106) compares the calculated energy value and the threshold value that was determined at the start, determines the voiced and unvoiced regions, and distinguishes them from one another accordingly.

Voiced region determiner (107) determines the starting point of the speech signal if the calculated energy value is greater than the threshold value and marks this point as K1.

Unvoiced region determiner (108) determines the ending point of the speech signal if the calculated energy value is smaller than the threshold value and marks this point as K2.

Loop continuator (109), after marking and calculation operations, transmits these markings to the region plotter and ensures that the calculation operation continues.

Region plotter (110) utilizes the points determined by the equality analyzer (106) and marked by the voiced region determiner (107) and the unvoiced region determiner (108) and detects the voice activity regions.

The method for detecting voice activity regions of the encoder subject to the invention comprises the following process steps. Initially, the speech signal (100) is received by the encoder. Subsequently, the speech signal is divided into analysis windows by the window divider (101). Initial value determiner (102) determines the initial values of Eₘᵢₙ, μ, and threoffset. Threoffset value is determined in order to create a certain amount offset on the threshold value in voiced/unvoiced decision and may be set to the desired value in the range of [0-0.1]. Energy average value calculator (103) calculates Eₘᵢₙ, Avgx, Thre and Esikdgr which are the average values in the unvoiced signal window range. Loop initiator (104) initiates the loop for analysis windows. Analysis window energy calculator (105) calculates the EwS(n) energy values (Equation 12) by obtaining the sum of squares of speech signal (100) values transformed by Equation 2. Equality analyzer (106) compares the calculated energy value and the threshold value determined at the beginning and separates voiced/unvoiced regions from one another. Equality analyzer (106) determines the speech starting point if the energy value is greater than the threshold value. Equality analyzer (106) determines the speech ending point if the energy value is below the threshold value. Voiced region determiner (107) determines and marks the starting point of the speech signal as K1 if the calculated energy value is greater than the threshold value. Regions that are above the threshold value are recorded as “voice active” regions. Unvoiced region determiner (108) determines and marks the ending point of the speech signal as K2 if the calculated energy value is below the threshold value. Subsequent to calculations and marking operations, the loop continuator (109) transmits the markings and continues the loop. Finally, region plotter (110) utilizes all points determined by the equality analyzer (106) and marked by the voiced region determiner (107) and by the unvoiced region determiner (108), and detects the voice activity regions for the entire input signal.

The energy calculation method of the energy calculator (105) in an analysis window (105) comprises the following process steps. Initially, calculated average signal noise amplitude value (avgx), compression parameter (μ), normalized input audio signal sequence (xi(n)) in the i^{th} analysis window, and the average energy signal threshold value (Eₘᵢₙ) are taken as input value (201). Subsequently, b1, b2, and k_{threshold} values are determined as an initial value (202). Value a is calculated (203). Value a is calculated as the difference (a=mean(xi(n))−Avgx) of the average value (mean(xi(n))) of signal amplitudes in i^{th} analysis window to average signal noisy amplitude value (Avgx) of speech signals at the initial unvoiced region. Coefficient k is calculated (204). Said coefficient is calculated by using Equation 3. An equality comparison is made with the k_{threshold} value of the coefficient k (205). If the calculation result shows that the coefficient k is smaller than the k_{threshold} value, then the coefficient k is equalized to k_{threshold} value (206). If the result of the respective calculation shows that the coefficient k is greater than the k_{threshold} value, then Fw(xi(n)) is calculated for xi(n), xi(n) being the transformed input signal in the analysis window (207). i^{th} analysis window transformed input signal xi(n) is calculated by using the Equation 2 (Fw(xi(n))). EwS(n) energy values are calculated subsequent to respective equalizations and calculations (208). EwS(n) energy values are calculated by using Equation 12. All of the aforementioned process steps are performed by the analysis window energy calculator (105). The EwS(n) value is transmitted to the encoder as the encoder energy value within the i^{th} analysis window.

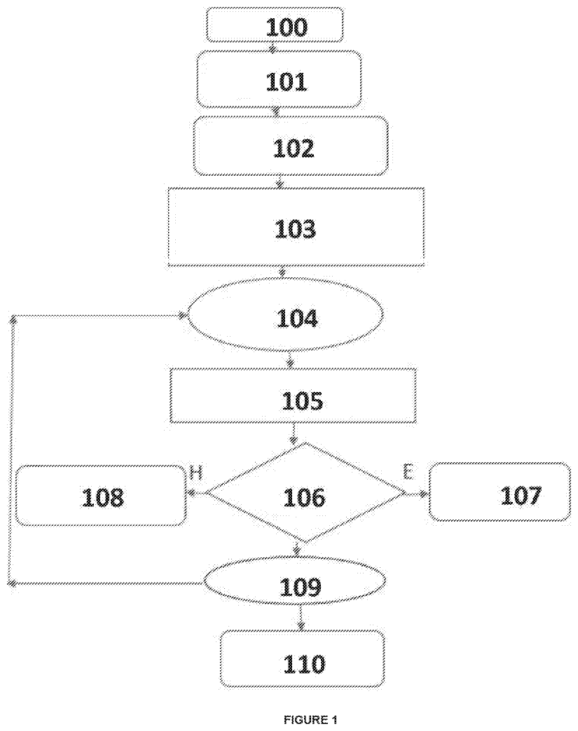

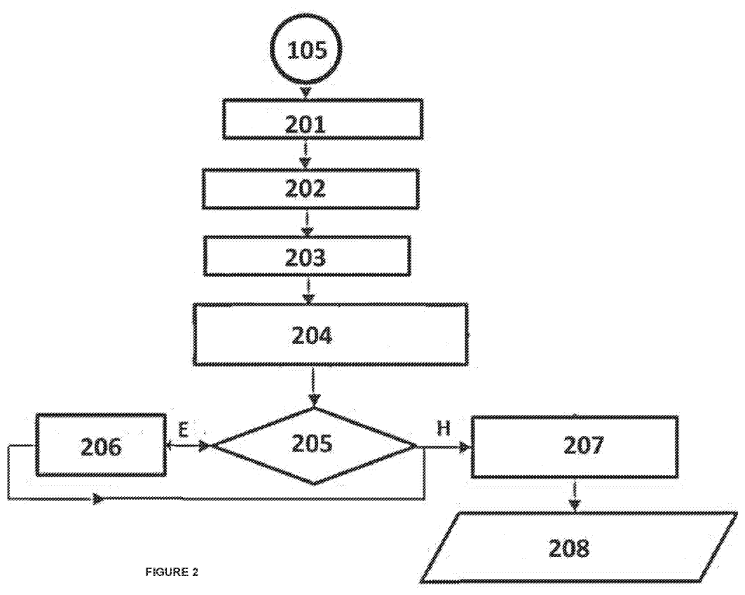

The amount of instant variation increases drastically even in the amplitudes in non-speech (unvoiced) regions while the voice activity regions (VAD) of input signals with a very high noise level and a very low SNR level are being determined, and accordingly, this may result in faulty voiced/unvoiced decisions since the amount of energy may be calculated high/low because of the increased instant variation intensity. In order to avoid this situation and to make more accurate voiced unvoiced decisions, the proposed alternative method using the encoder of the invention is as follows; the accuracy of respective decisions may be increased by monitoring the signal energies throughout a few analysis windows instead of making voiced/unvoiced region decisions by considering the energy of the signal within each analysis window for input signals with very high noise levels and with too many instant amplitude variations. In such a case, energy amounts of the encoder of which block diagram are provided in FIGS. 1-2 are calculated throughout a few analysis windows, and the average energy values in these regions may be checked whether they are below the Esikdgr (Equation 13). If the average energy value is smaller than the Esikdgr, voiced/unvoiced decision pertaining to the entirety of the regions is rendered as ‘unvoiced’ and thus, any potential ‘voiced’ region decisions that may be made instantly for unvoiced regions without any speech may be prevented. Hence, the accuracy rate of voiced/unvoiced decisions may be increased. In such a case, however, a certain amount of time delay will emerge for a real-time application since a delay with the duration of selected analysis windows will be introduced into the system. Analysis sub-windows are not necessary in case the noise level of the input signal is not too high.

μ-law compression/encoding method used in the state of the art is utilized for compressing the speech signal while it is transmitted over the communication lines. For a normalized audio signal (x(n)) input sequence, the relation between the input signal and the compression rate is provided by Equation 1.

The method used for encoding the input signals by means of the encoder subject to the invention is given in Equation 2.

This equation (Equation 2) is developed based on the μ-law method for the purpose of calculating the energies of noisy signals in particular. Energy amplitude values yield satisfactory results when the energy calculation indicated in Equation 11 is performed for F(x(n)) signals transformed through the μ-law technique shown in Equation 1. However, the energy amplitude values of F(x(n)) noisy audio signals calculated through the μ-law method decrease rapidly. Therefore, the μ-law compression method is redefined as in Equation 2 and is used for calculating the energy of the speech signal and detecting the voice activity regions (VAD).

$$Fw ( x ( n ) ) = sgn ( x ) \cdot ln ( 1 + μ \cdot \vert x ( n ) \vert ) / ln ( 1 + k \cdot μ ) , - 1 \leq x ( n ) \leq 1 , \qquad ( 2 )$$

$$k = {e}^{- ( b 1 \cdot \sqrt{a} + b 2 ) \cdot Emin} , b 1 : [ 1 - 100 ] , b 2 : [ 0 - 1 ] , \qquad ( 3 )$$

$$a = ( \frac{1}{N} {\sum }_{n = i \cdot N}^{i \cdot N + N - 1} \vert x ( n ) \vert - avgx ) , i : analysis window number \qquad ( 4 )$$

$$avgx = \frac{1}{f \cdot N} {\sum }_{n = 1}^{f \cdot N - 1} \vert x ( n ) \vert , \\ f = inital number of unvoiced analysis windows \qquad ( 5 )$$

N: x in the analysis window(n) number of elements for the signal

$${E}_{min} = \frac{1}{f} {\sum }_{i = 1}^{f} {E}_{i} \qquad ( 6 )$$

$$Thre = max ( {E}_{i} ) , i = 1 , ... , f \qquad ( 7 )$$

Amplitudes of x(n) input signals, energy levels of Fw(x(n)) signal in the Equation 2 obtained by being recomposed according to μ value are calculated by using the Equation 12, and accordingly, good results are obtained in these energy levels, resistance to noise as well as in speech region detection performed according to these energy levels.

Eₘᵢₙ value denoted herein is the average energy value of unvoiced region analysis windows selected at the beginning (Equation 6). The calculation of Eₘᵢₙ value was initiated by assuming it as Eₘᵢₙ=0. Analysis windows of a number f (f, based on the length of the selected analysis window, (may optionally be selected such that it is in a range between (1 and 10) are selected at the beginning of the speech signal, and average noise energy value (Eₘᵢₙ) of Fw(x(n)) signal, which is transformed with Equation 2, in unvoiced regions is calculated by assuming that these analysis windows of a number f do not comprise speech. Moreover, the average signal noise amplitude value (avgx) of selected analysis windows of a number f is calculated (Equation 5). Noise energy values in unvoiced regions were recalculated twice by means of the encoder subject to the invention in the range of analysis windows of a number f by using calculated Eₘᵢₙ value in order to obtain a stable minimum Eₘᵢₙ value and a Thre value since energy amplitude values increase drastically in signals with high noise levels in particular, and Eₘᵢₙ value and Thre value were calculated from these energy values. Maximum energy value in silent analysis windows at the beginning in the Equation 6 was recorded as the energy threshold value (Thre) so as to be used in the selection of value k in the energy calculation in order to minimize the effects of small changes in the signal affecting the voiced/unvoiced decision and to ensure that these small changes in the energy calculation of noisy signals in particular, do not affect voiced/unvoiced decision (Equation 7) (Selecting this value instead of Eₘᵢₙ serves the purpose of minimizing the influence of instant energy changes of noisy input signals).

Energy amplitude values of F(x(n)) signals calculated in Equation 11 by using the μ-law technique shown in Equation 1 decrease rapidly in noisy audio signals. On the other hand, the energy values of noisy signals increase when the denominator in Equation 1 is decreased. In this regard, energy amplitude levels were tried to be stabilized without any reduction even in signals with high noise levels by adding a multiplier ‘k’ like the one in the Equation 2 to the μ-law technique and the suitable multiplier ‘k’ value was searched. Initially, the value k was changed in a range between [1-0.005] in order to investigate its effects on Equation 2. Also, the effects of μ were tested for different k values when [1, 10, 50, 100, 150, 200, 250] values are selected since the selected μ value has effects on the formula as well. Respective test results are illustrated in charts shown in Figures between [3-14]. Said test results indicate that when the input value varies in a range between x:[1:1], Fw(x(n)) result is affected significantly (e.g. varies in a range between Fw(x(n)): [0-80 dB] for μ=1) upon k value's change between [1-0.005] range for smaller μ values and variation range of Fw(x(n)) becomes smaller against the changed k values as the μ value becomes greater. (e.g. different k values' effect on Fw(x(n)) result is in a range between [0-5 dB] for μ=200). Its effect on Fw(x(n)) result becomes slower after μ=100 value. However, the variation range of k was limited in a range between [1-0.005]since the Fw(x(n)) variation range increases significantly in reference to the input signal (x(n)) value once the k value drops below 0.005. A formula that is capable of increasing the gain of the noisy input x signal values in a range between [−1:1] for Fw(x(n)) equation was tried to be generated as the primary aim of this study was to find a formula that can increase the energy gain values of the input signals for noisy input signals. A relation was searched between noisy signal energy threshold value which overlaps the input signal and the value k. A factor k value, in which energy amplitude levels can be maintained, was searched by adding Gaussian noise signal at gradually changed rates between [50 dB-0 dB] (decibel) to the normalized clean input speech signal. Test results indicated that k value varies exponentially with the input signal energy threshold value.

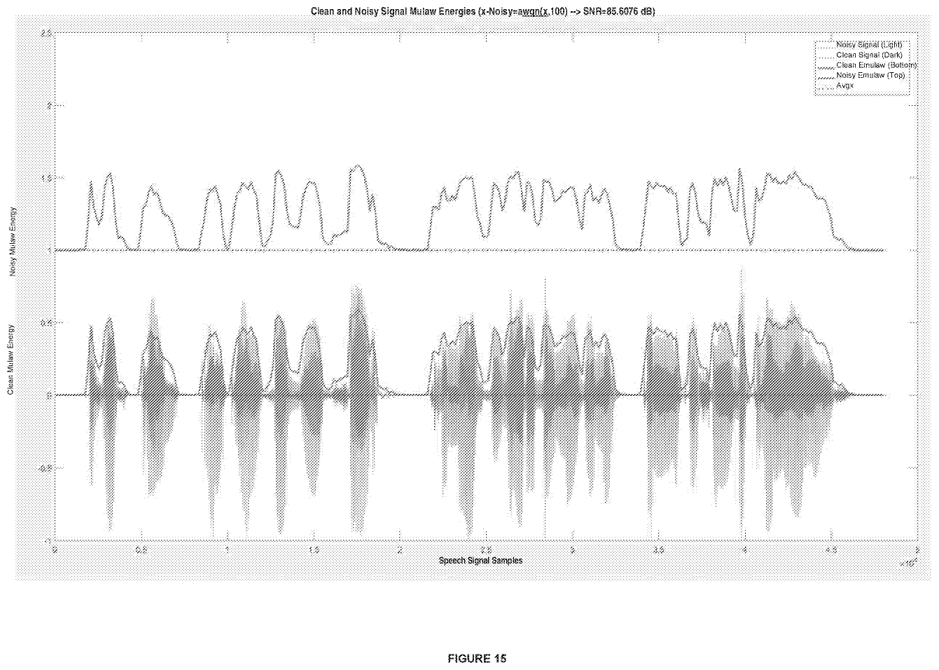

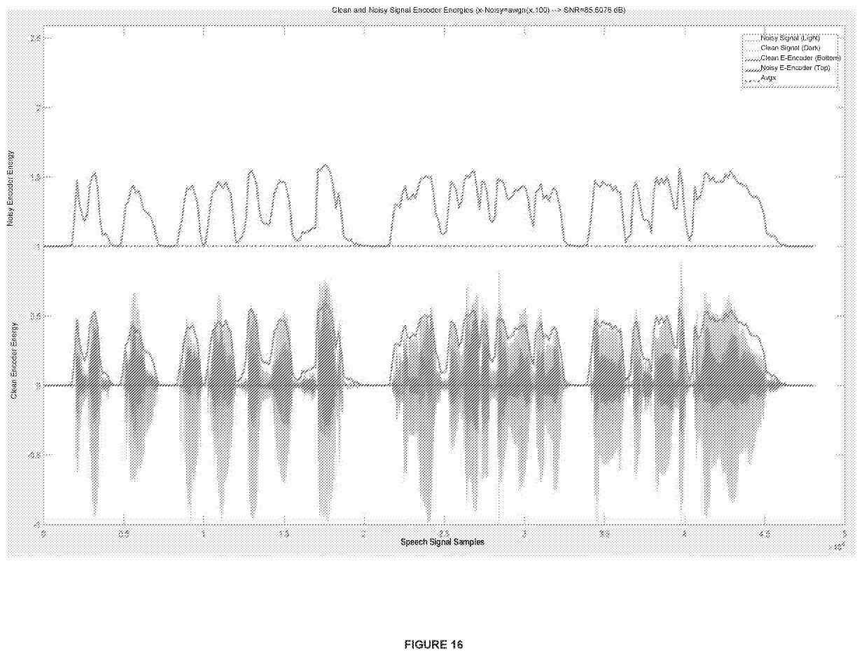

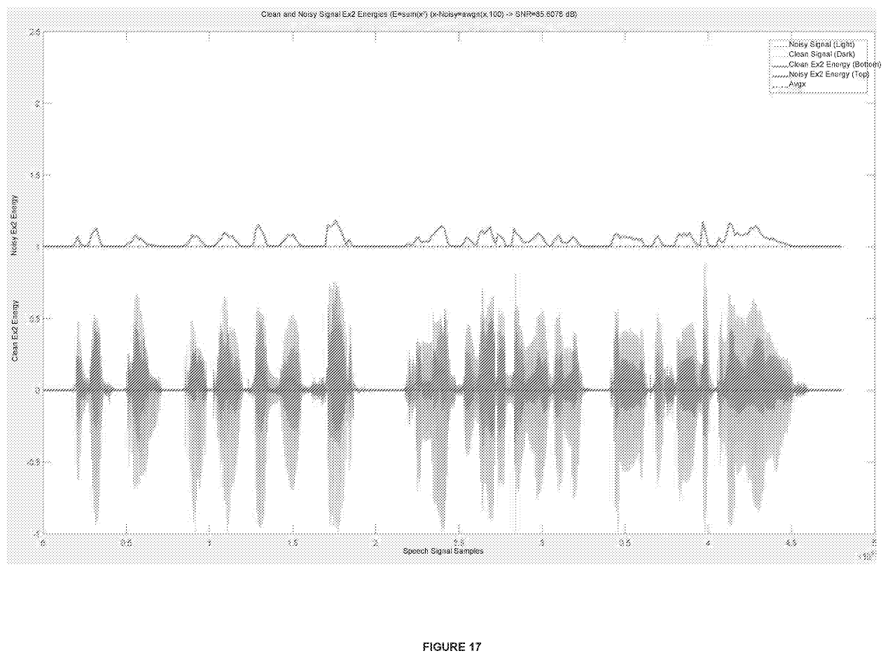

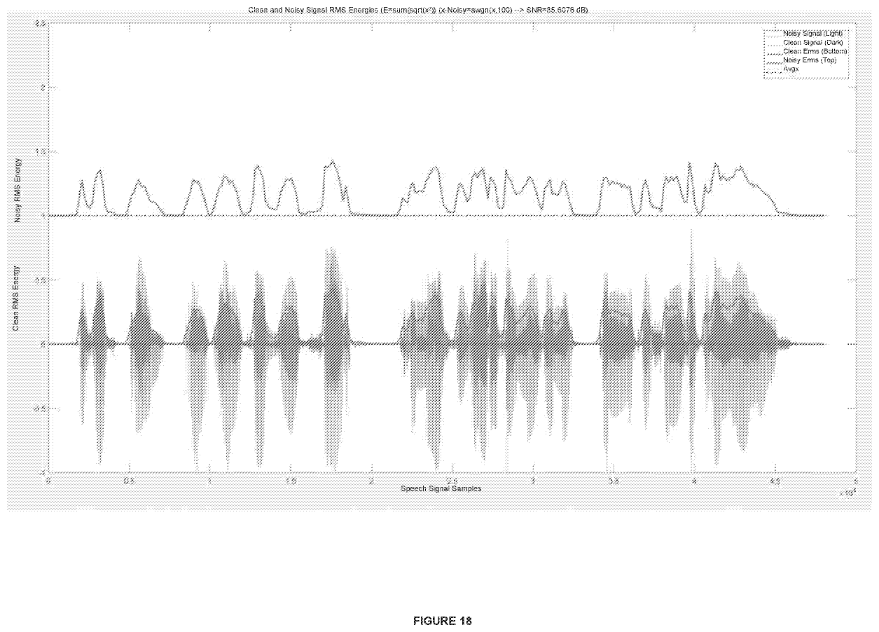

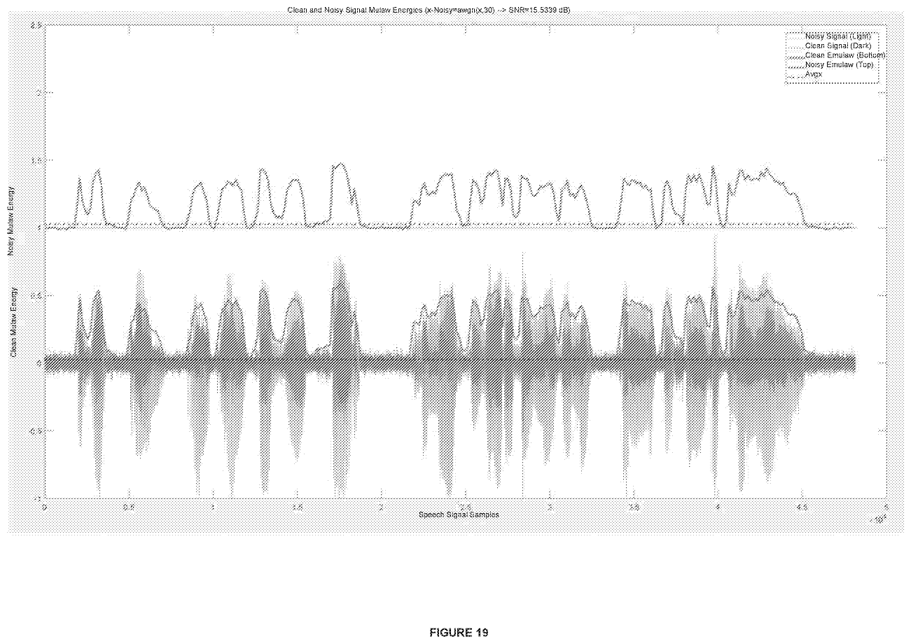

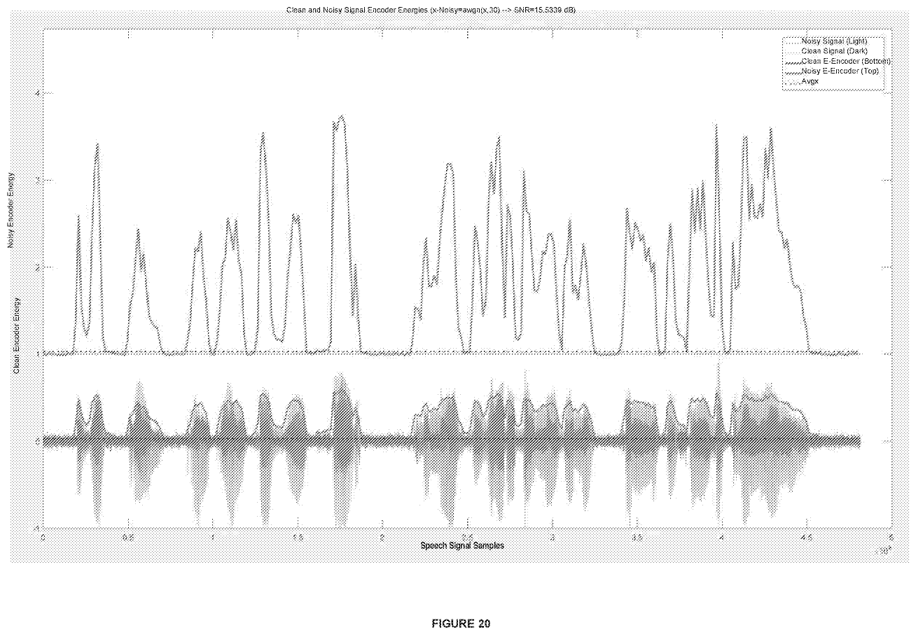

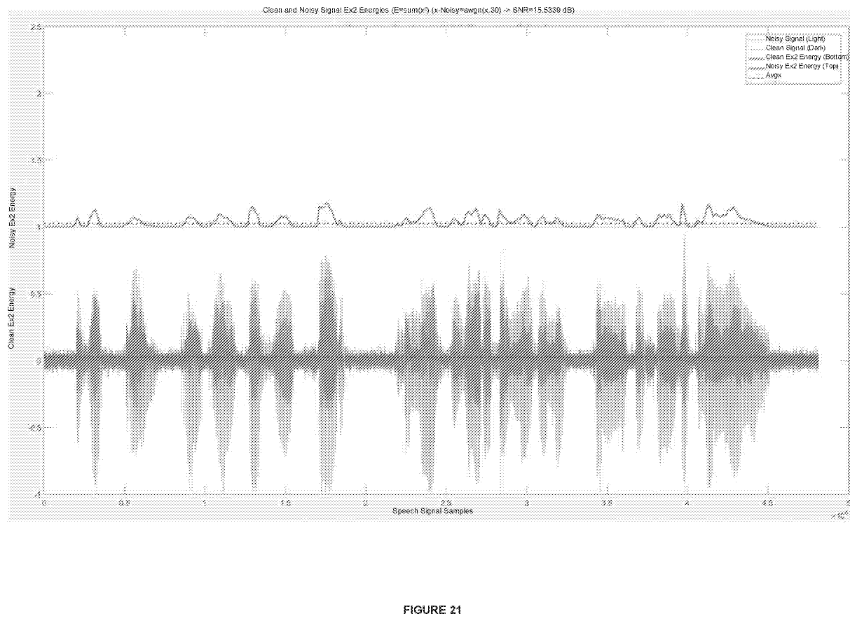

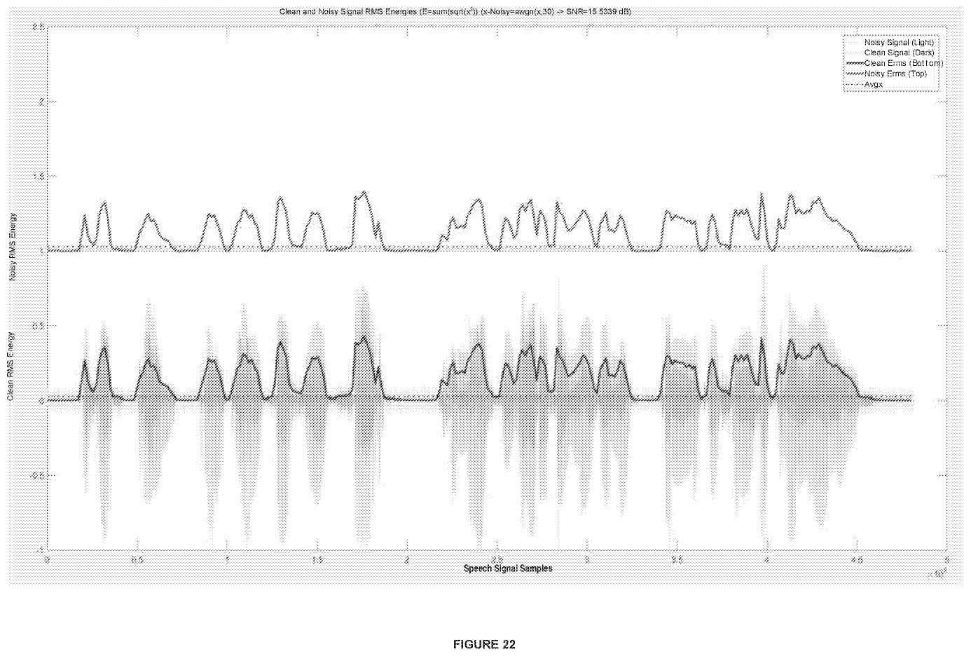

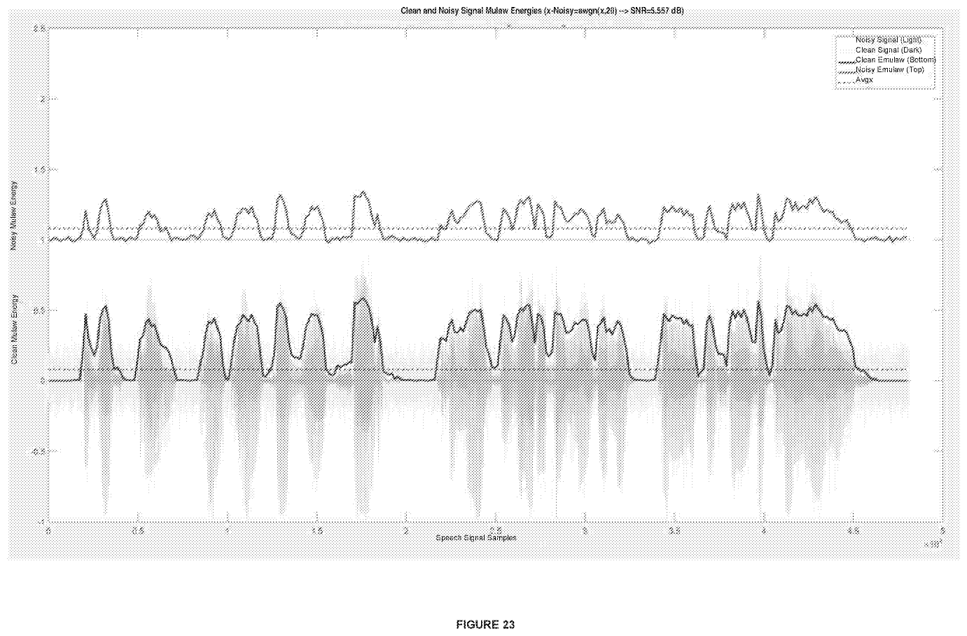

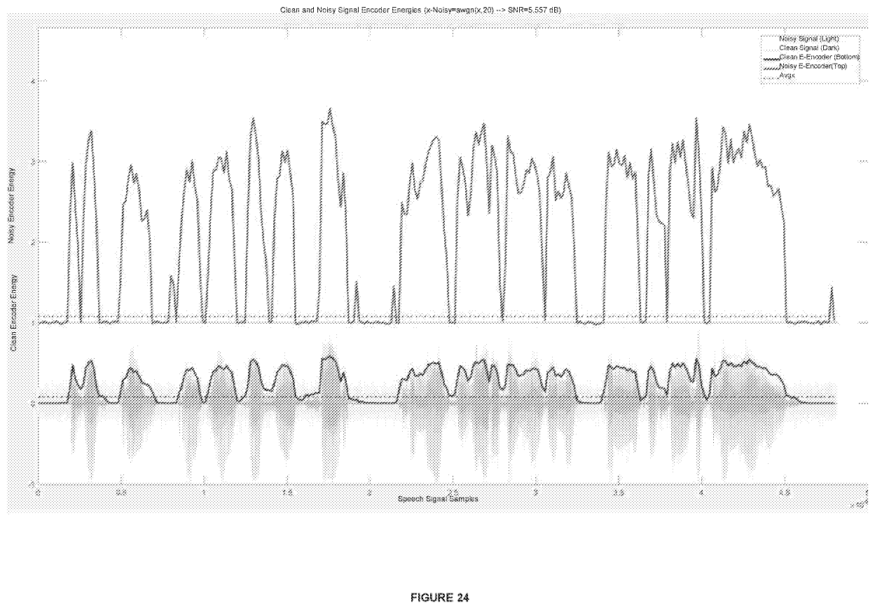

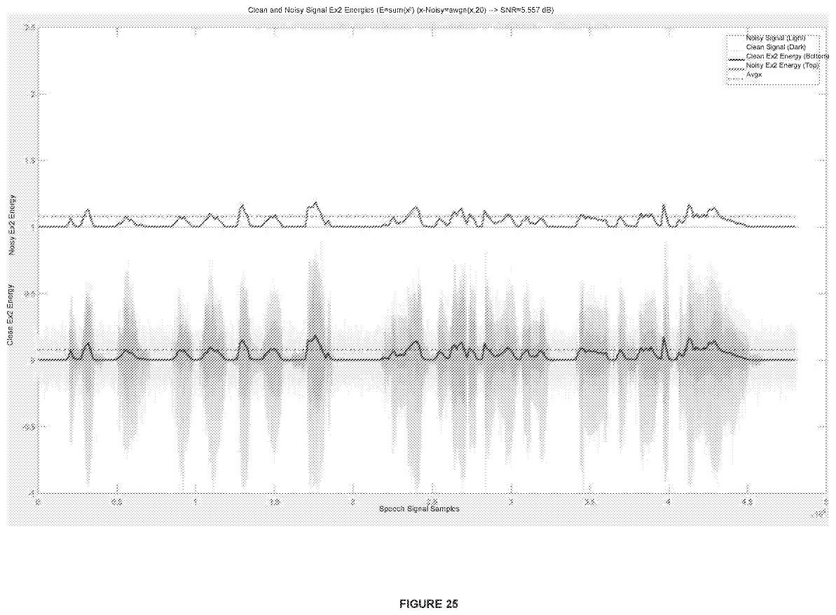

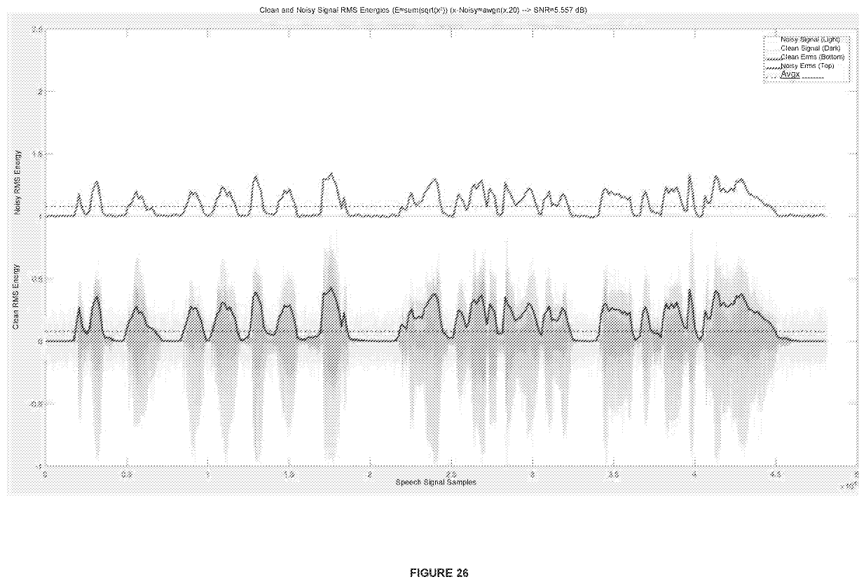

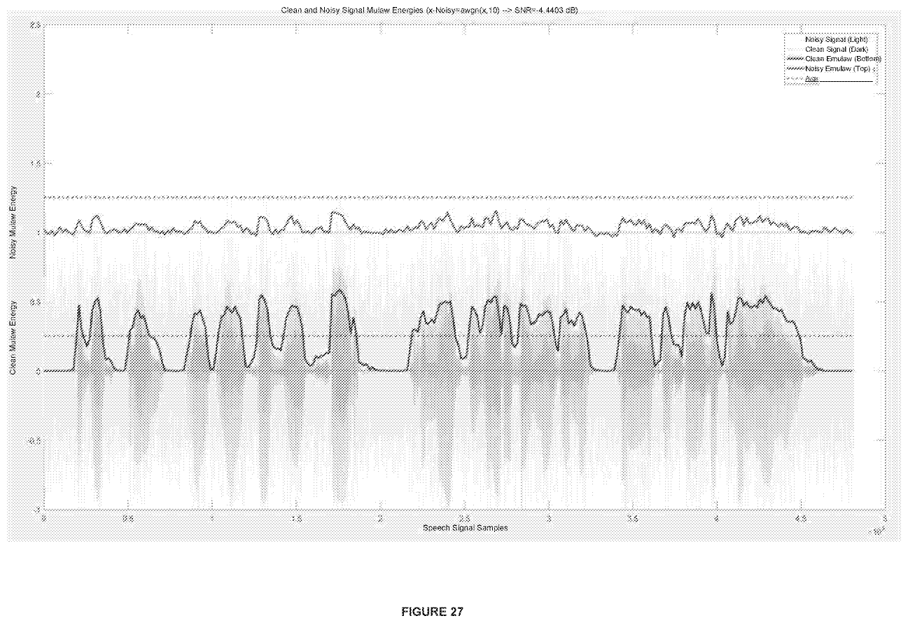

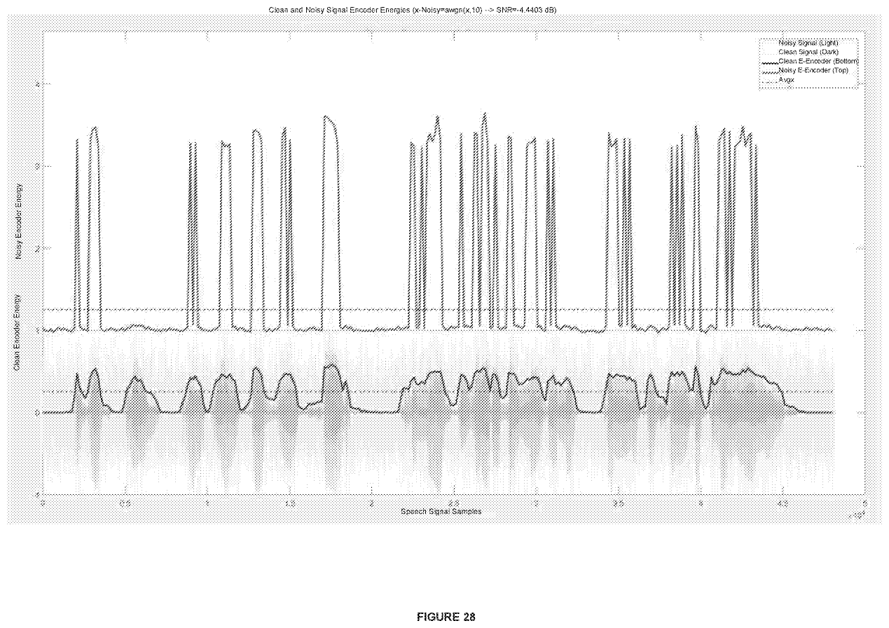

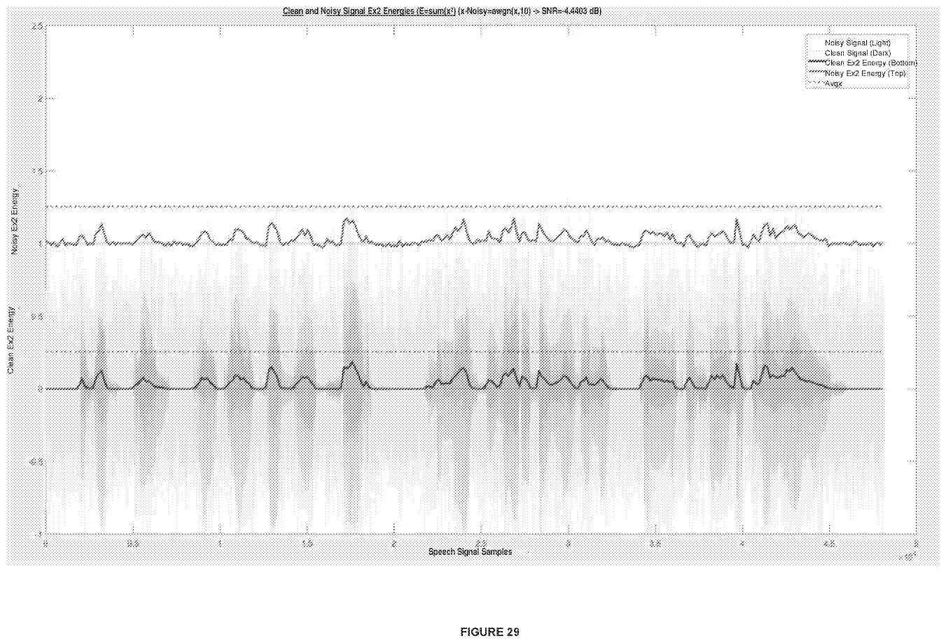

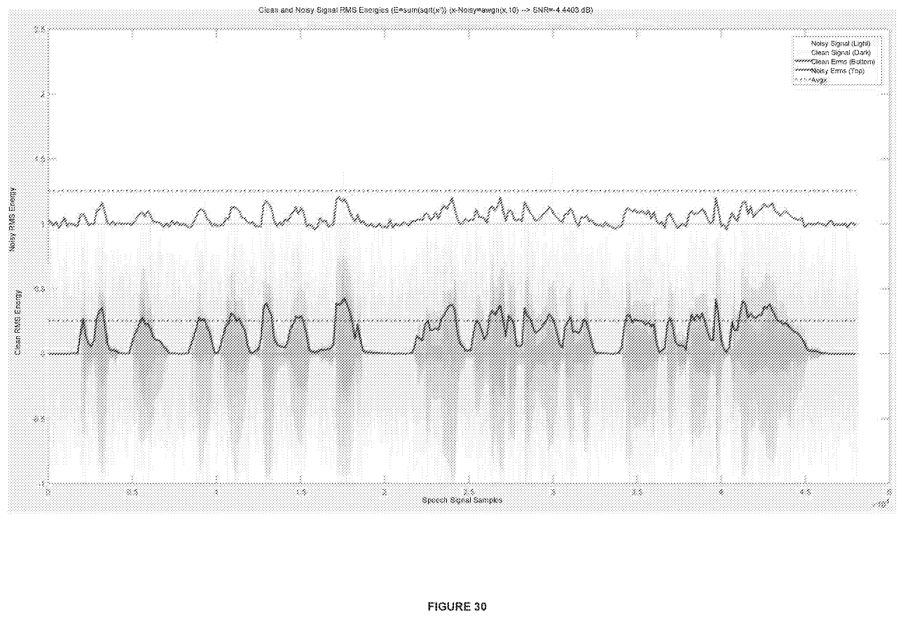

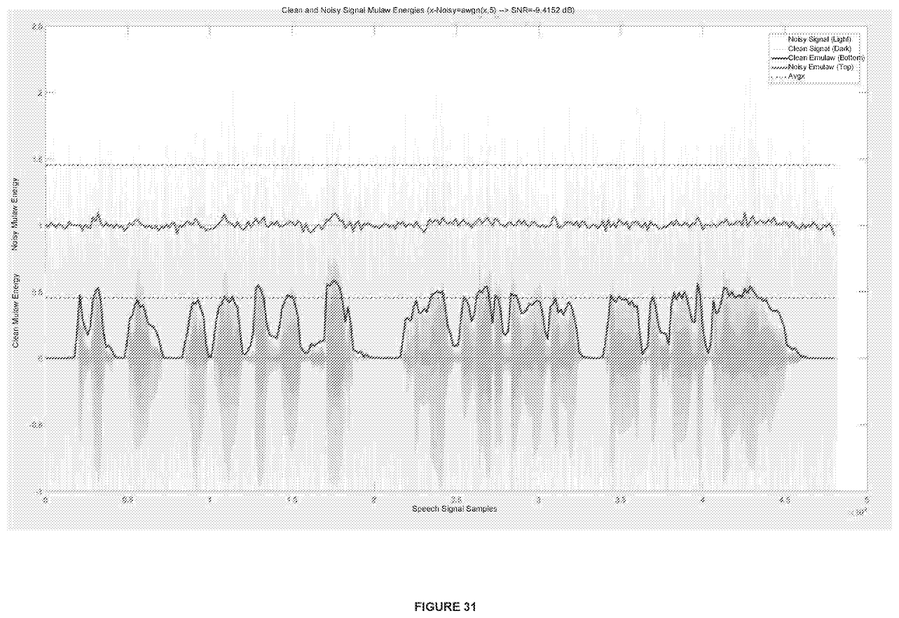

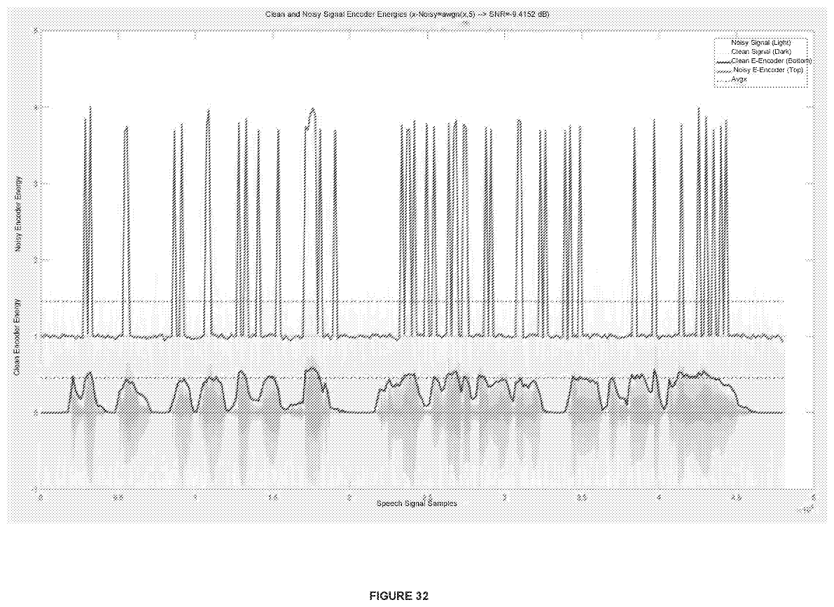

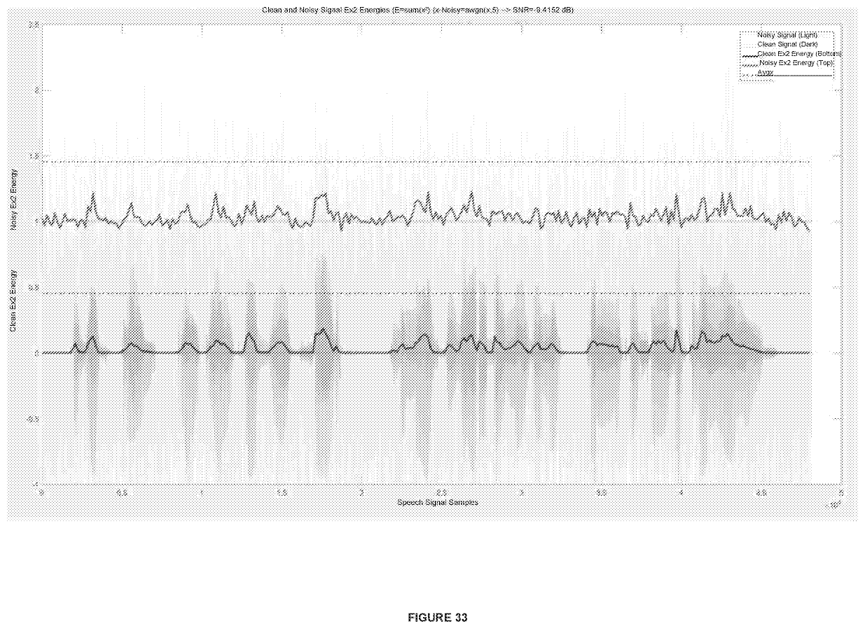

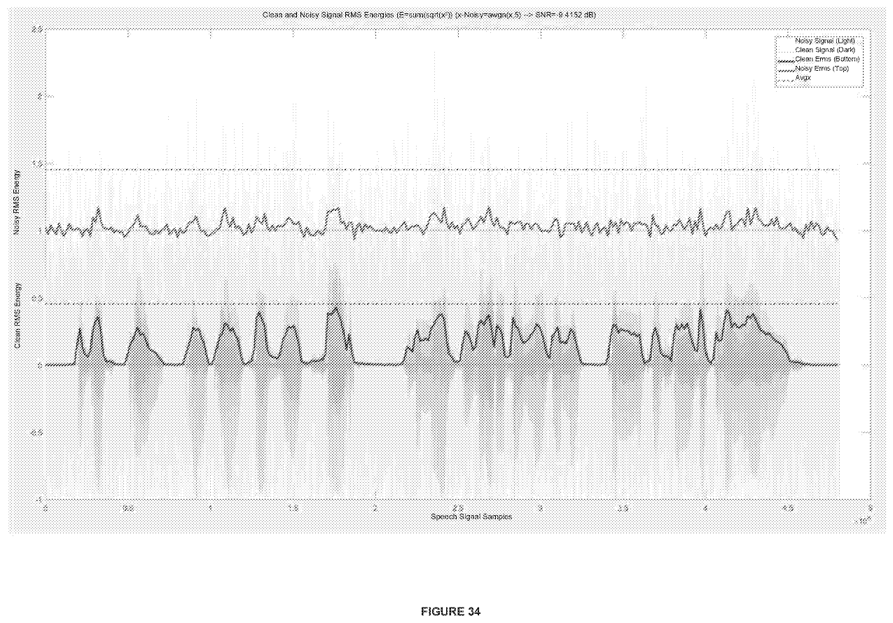

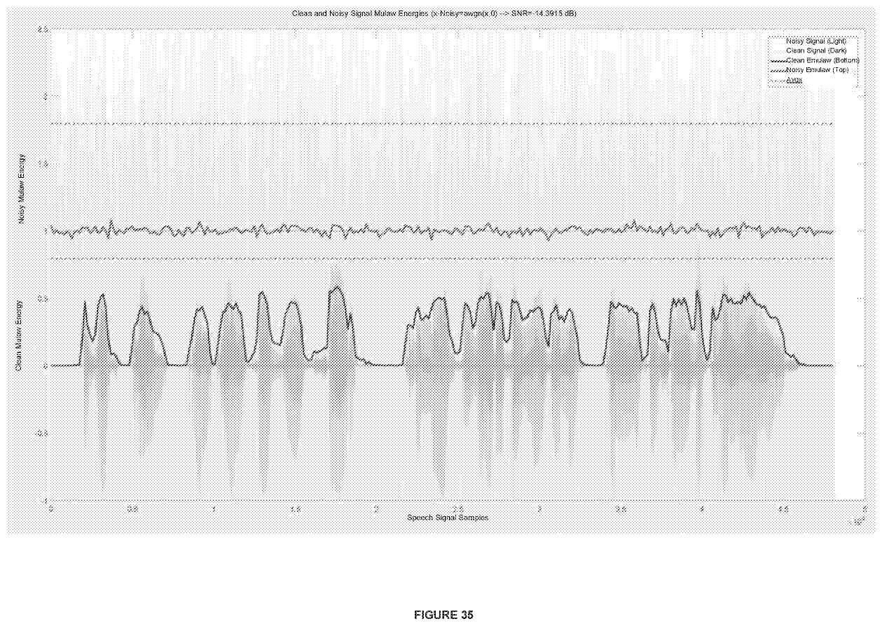

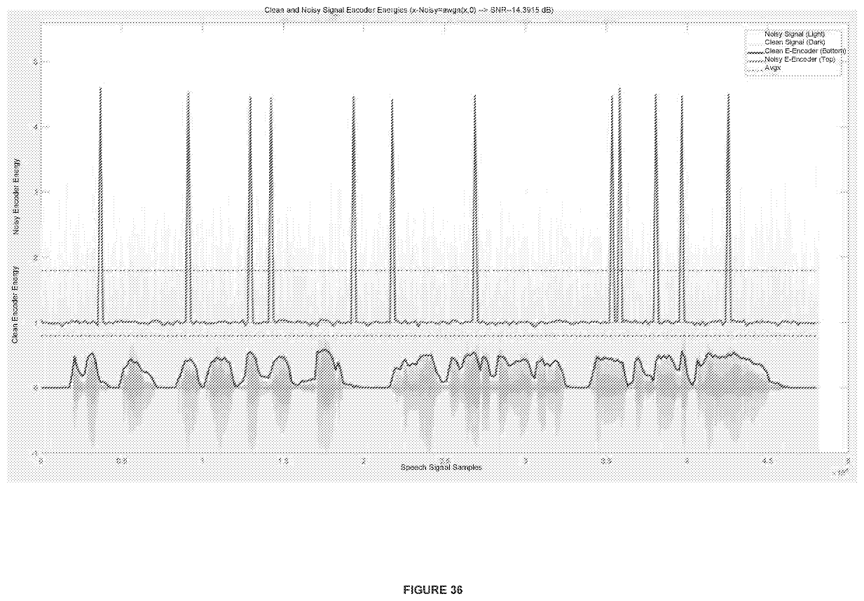

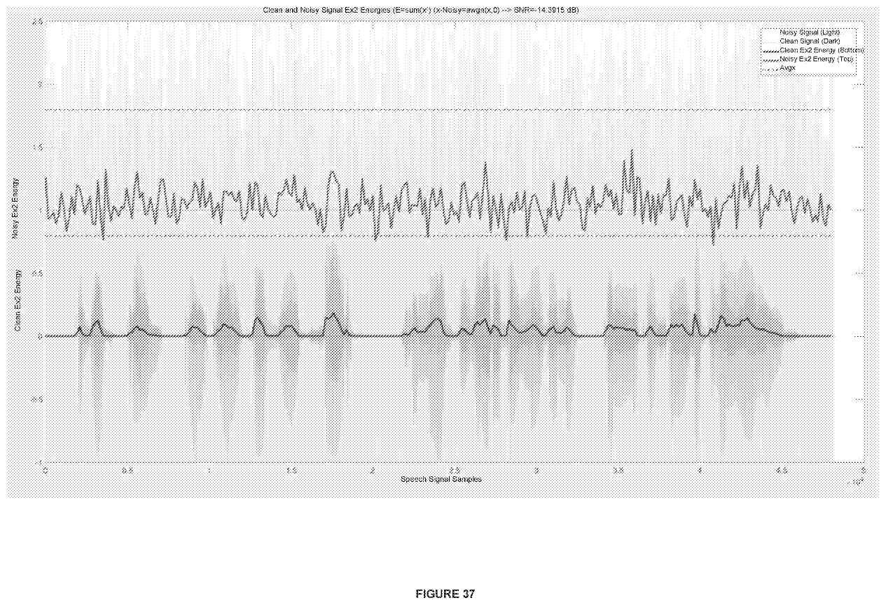

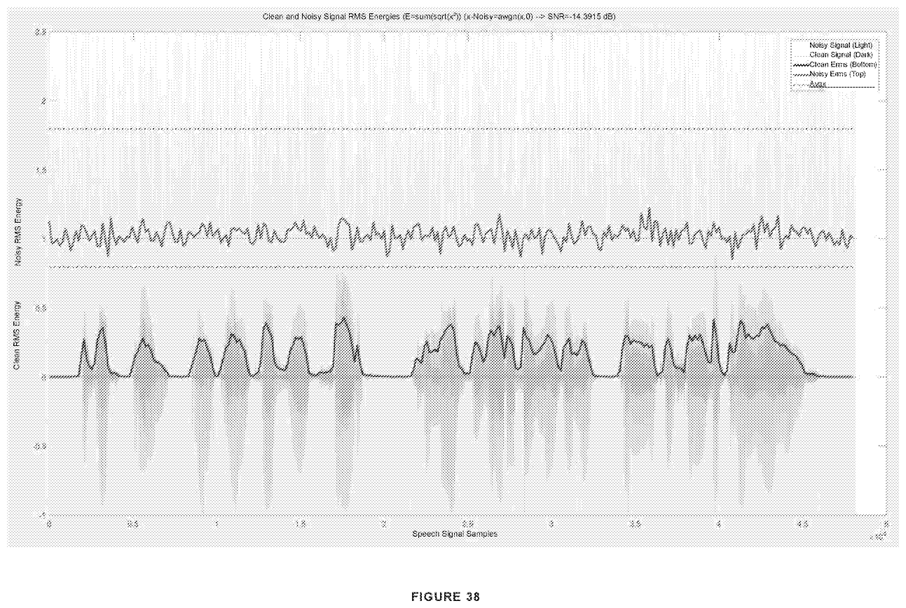

The input speech signal (x(n)) in the time domain is divided into analysis windows having N number of elements and of a total number of M by means of windowing method in the energy calculation performed with the encoder subject to the invention, and the speech signal (x(n)) in said analysis window is transformed into a new signal (Fw(x(n))) in the time domain through the Equation 2 by means of implementing the inventive method. Speech signal energy in each analysis window is calculated from Fw(x(n)) signal by means of the energy calculation formula provided in Equation 12. M, in Equation 12, denotes the analysis window number at any moment. The efficacy of the energy method of Equation 12 on various speech signals was compared with conventional energy methods that are calculated directly from the input signal in Equation 8 and Equation 10 and the comparison yielded exceptionally good results. Respective test results are illustrated in charts shown in FIGS. 15-38. (In accompanying figures, energy amplitude values in silent VAR regions that remain below the threshold were plotted by selecting k=1 to be able to distinctively demonstrate the amplitudes on the threshold value by means of the encoder subject to the invention. Moreover, noisy signal energies were plotted on the horizontal axis by being shifted by one unit on the same graphic display in order to show the energy differences of noisy input signals.)

$$Erms ( m ) = \sqrt{( \frac{1}{N} ) {\sum }_{n = m \cdot N}^{m \cdot N + N - 1} {x ( n )}^{\hat{}} 2} , m = 1 , ... , M \qquad ( 8 )$$

$$Ewrms ( m ) = \sqrt{( \frac{1}{N} ) {\sum }_{n = m \cdot N}^{m \cdot N + N - 1} {Fw ( x ( n ) )}^{\hat{}} 2} , m = 1 , ... , M \qquad ( 9 )$$

$$E ( m ) = ( \frac{1}{N} ) {\sum }_{n = m \cdot N}^{m \cdot N + N - 1} {x ( n )}^{\hat{}} 2 , m = 1 , ... , M \qquad ( 10 )$$

$$Ewmu ( m ) = ( \frac{1}{N} ) {\sum }_{n = m \cdot N}^{m \cdot N + N - 1} {F ( x ( n ) )}^{\hat{}} 2 , m = 1 , ... , M \qquad ( 11 )$$

$$EwS ( m ) = ( \frac{1}{N} ) {\sum }_{n = m \cdot N}^{m \cdot N + N - 1} {Fw ( x ( n ) )}^{\hat{}} 2 , m = 1 , ... , M \qquad ( 12 )$$

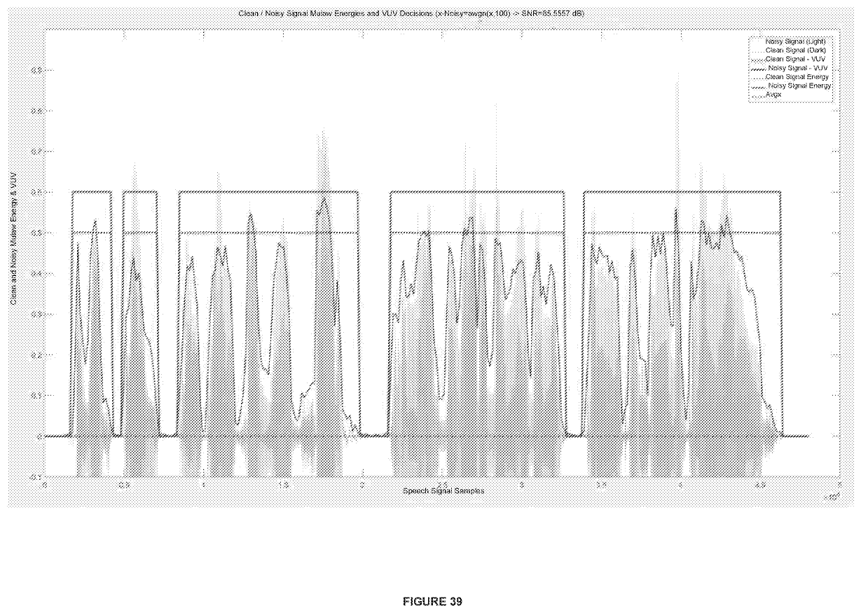

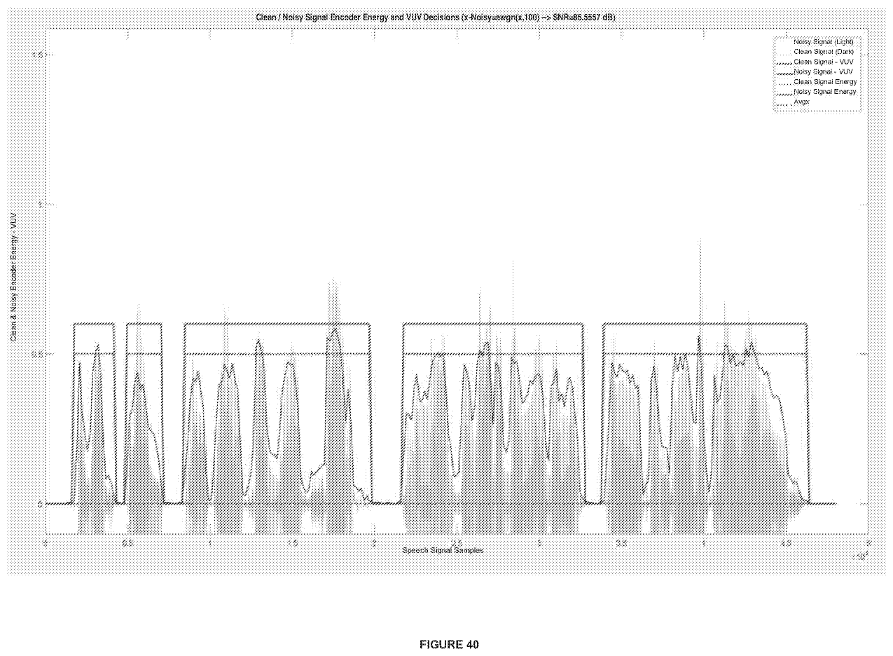

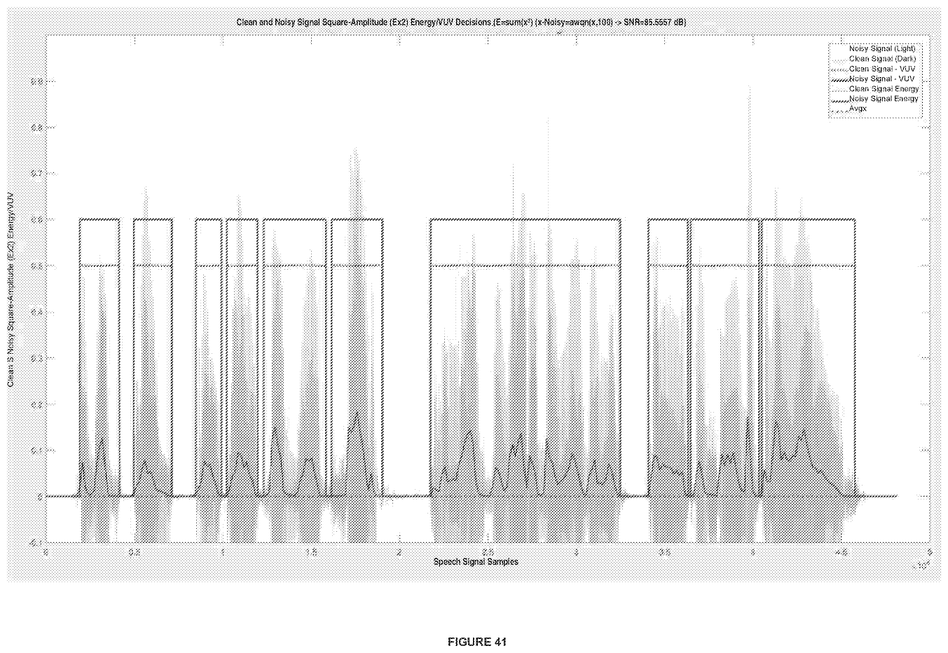

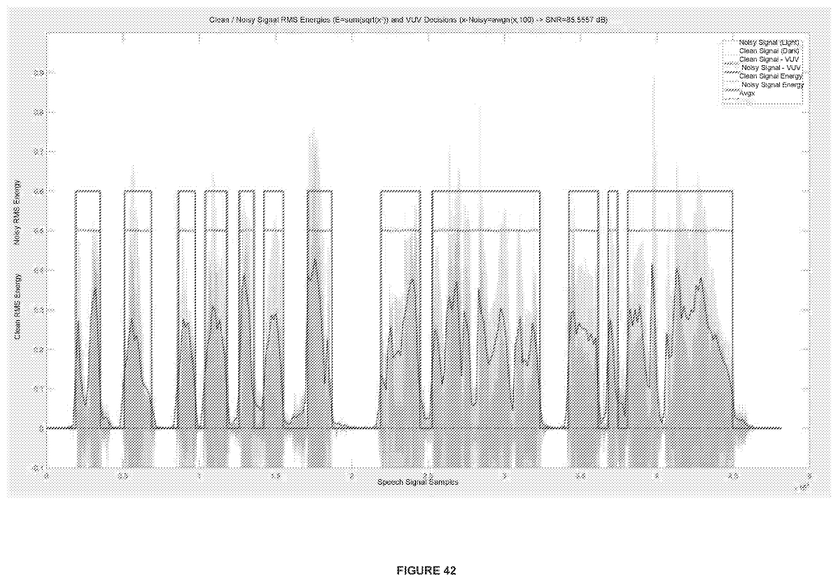

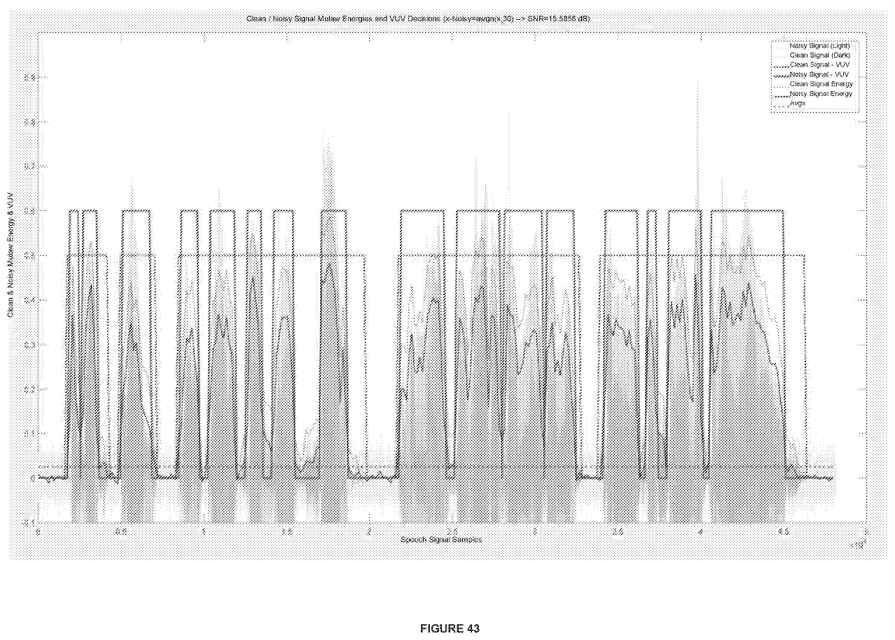

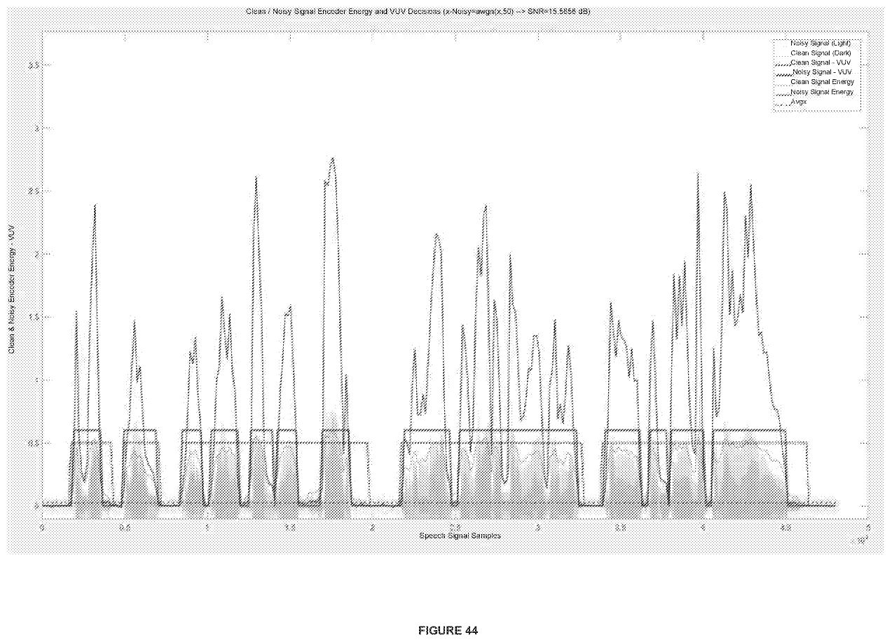

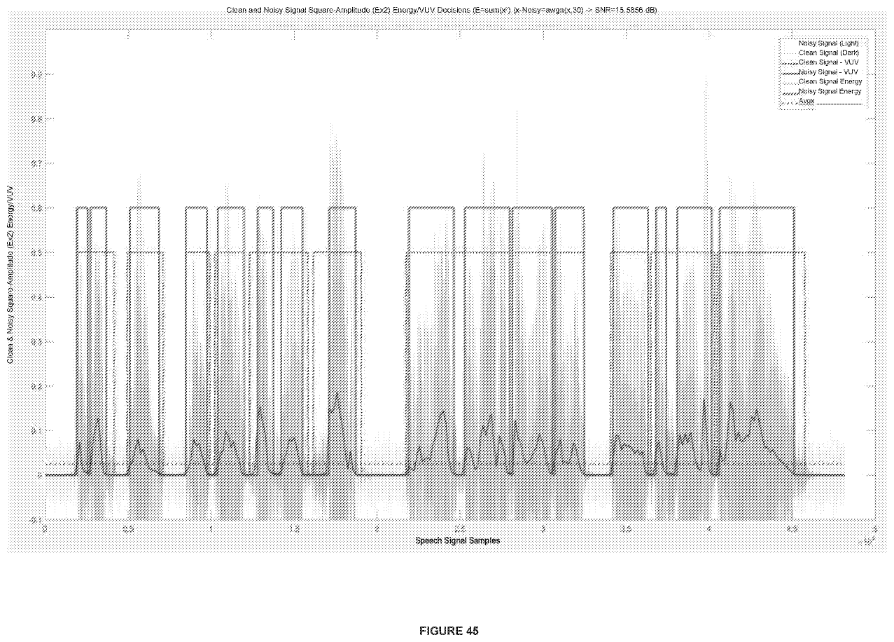

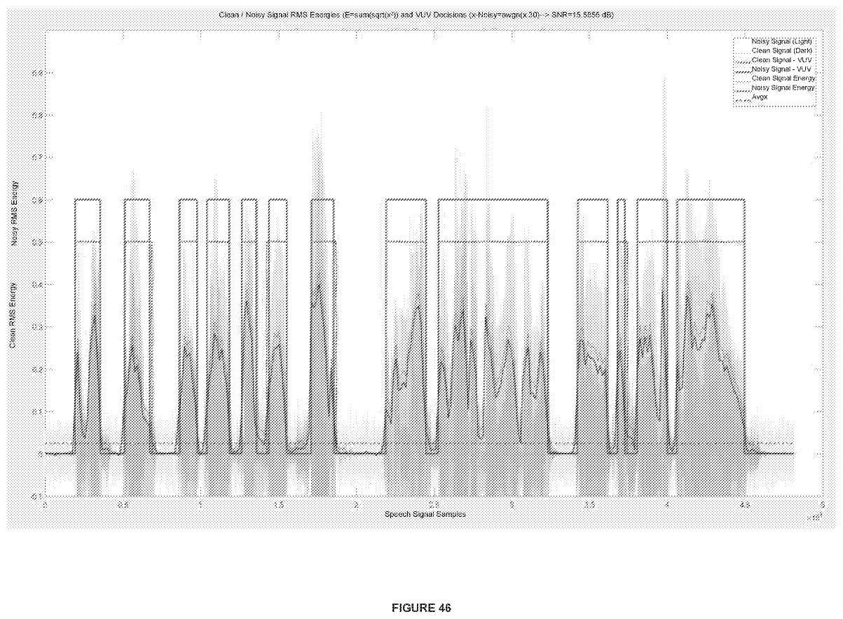

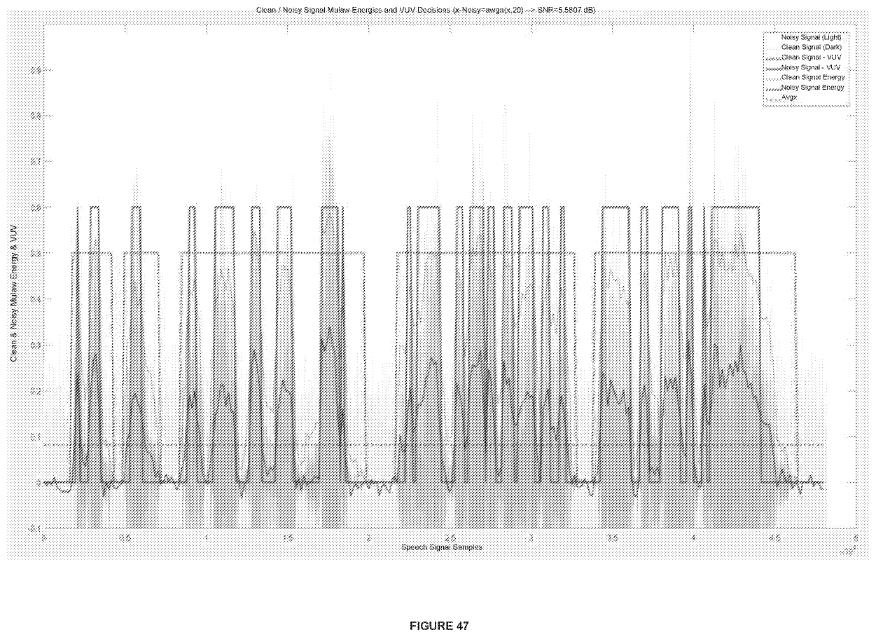

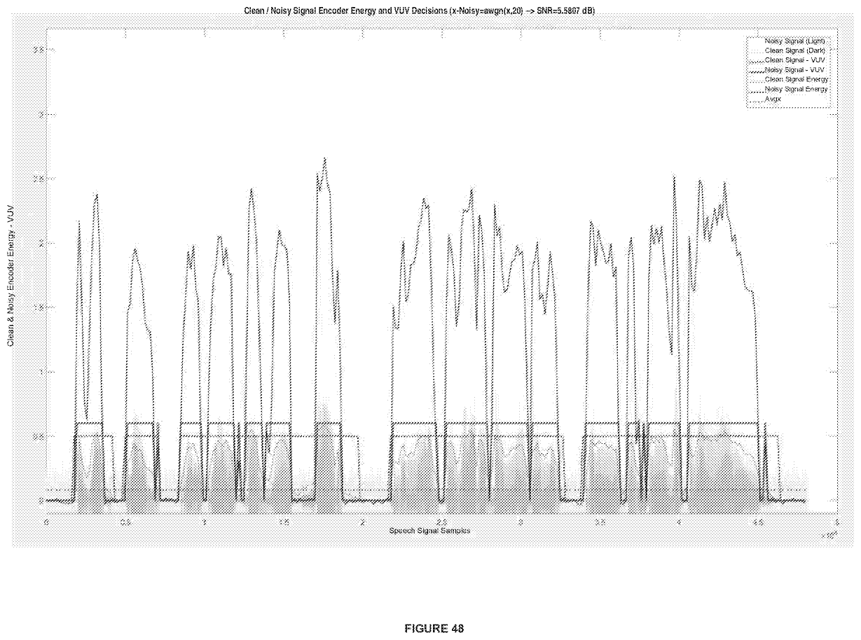

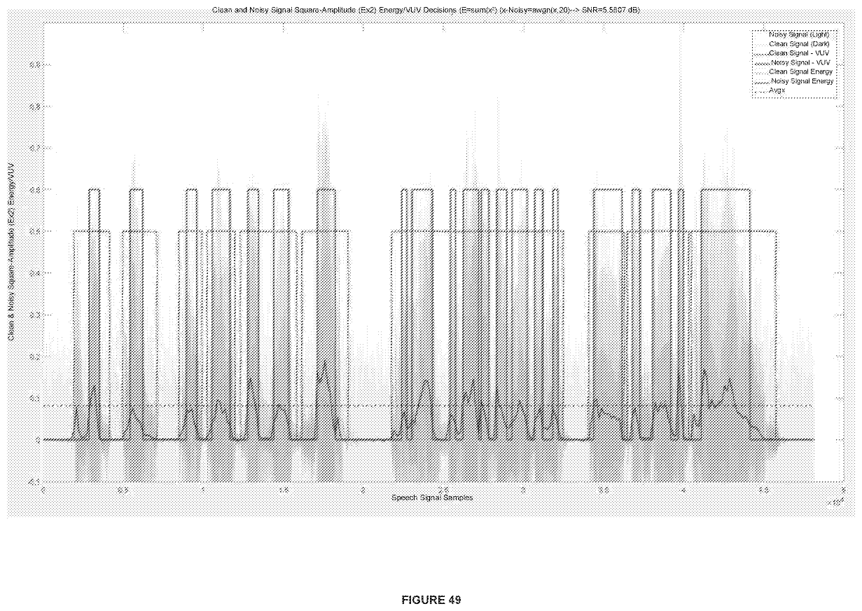

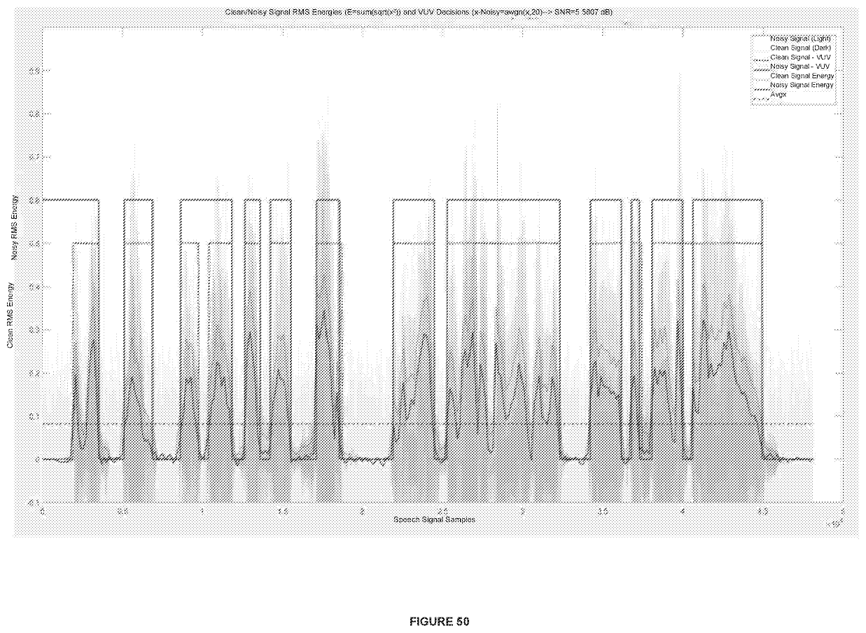

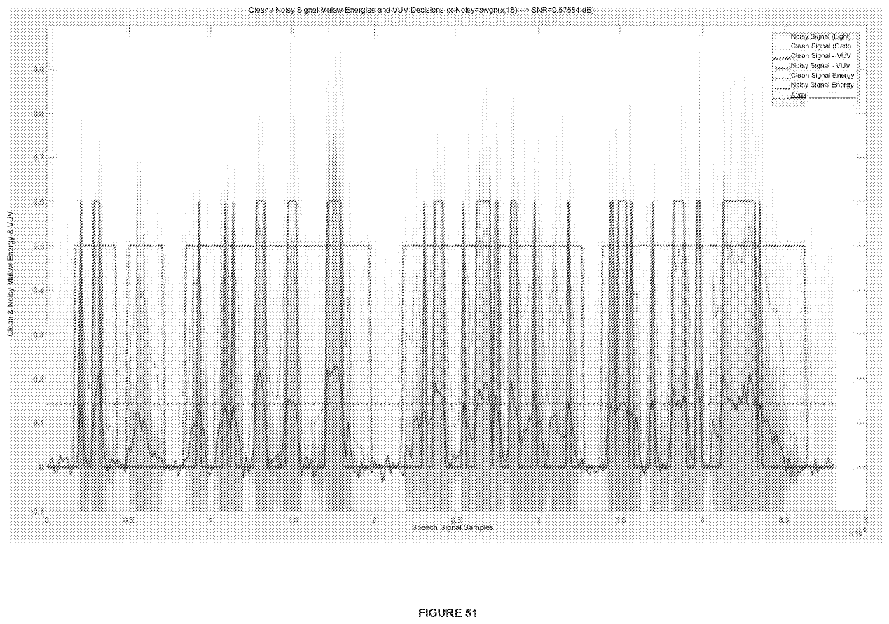

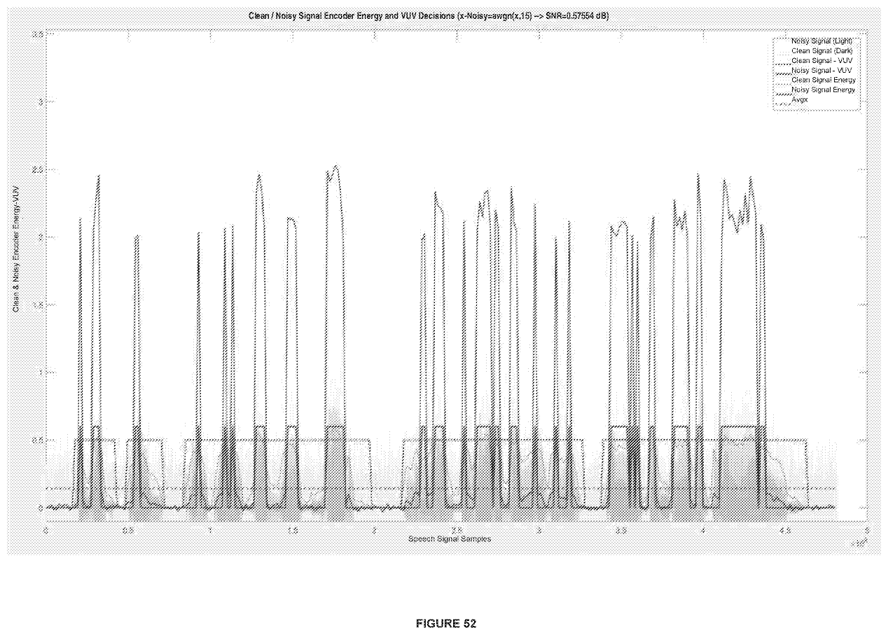

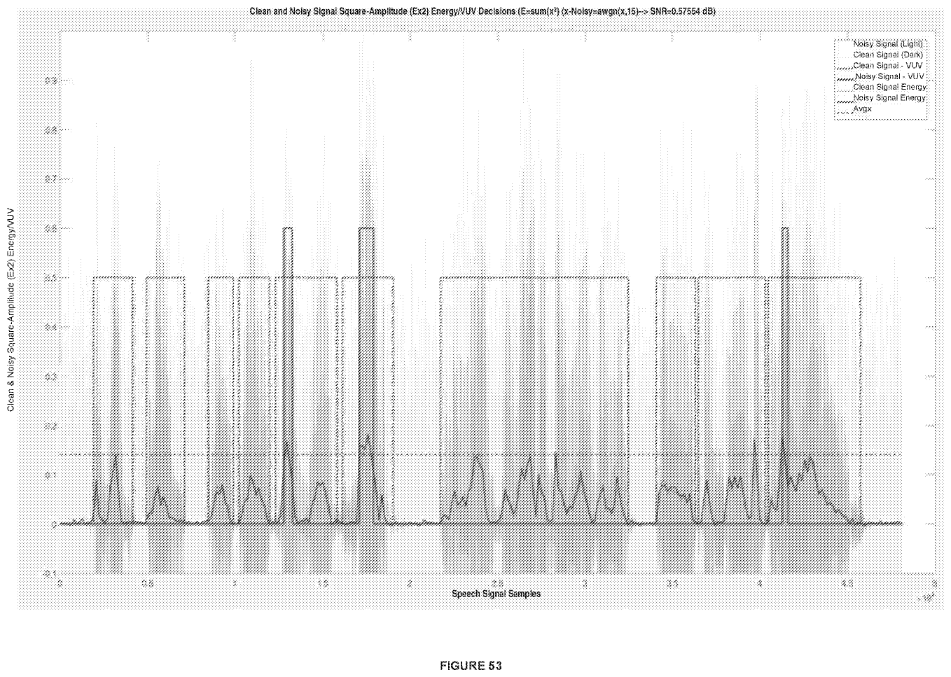

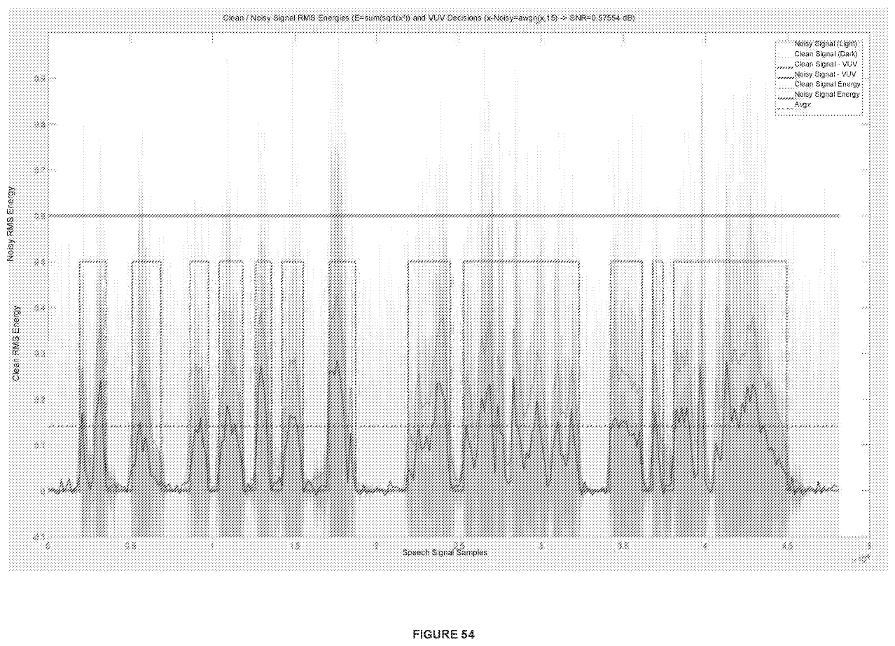

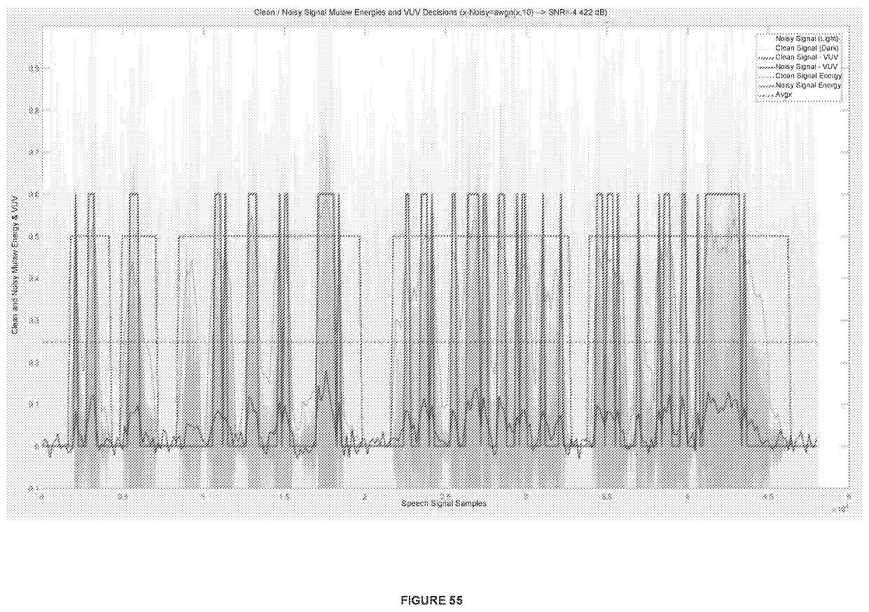

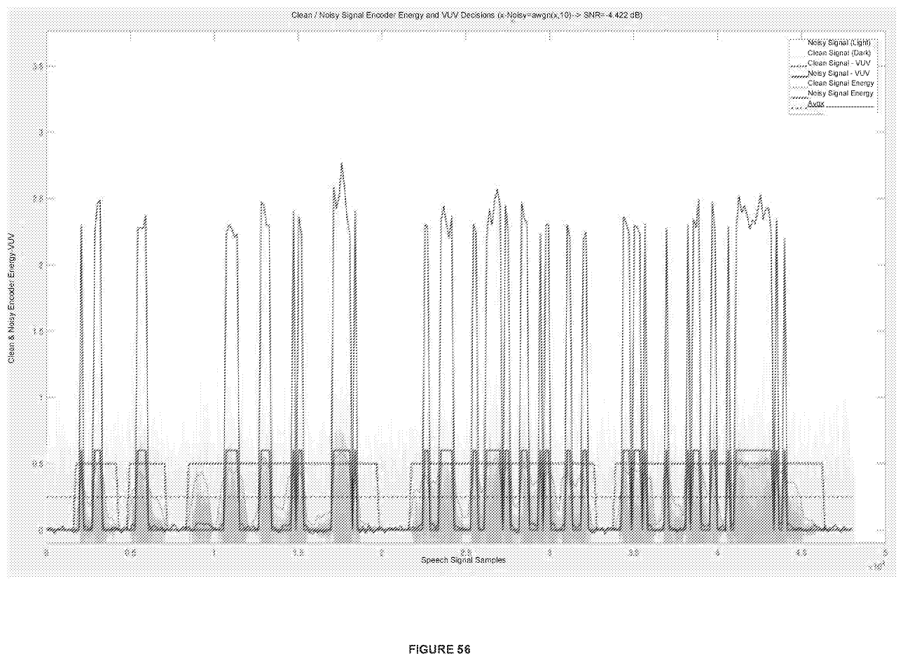

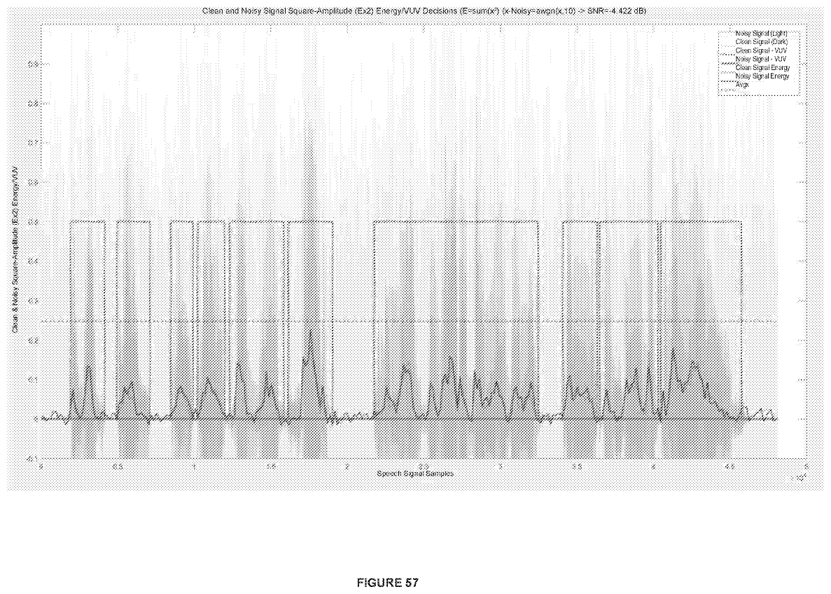

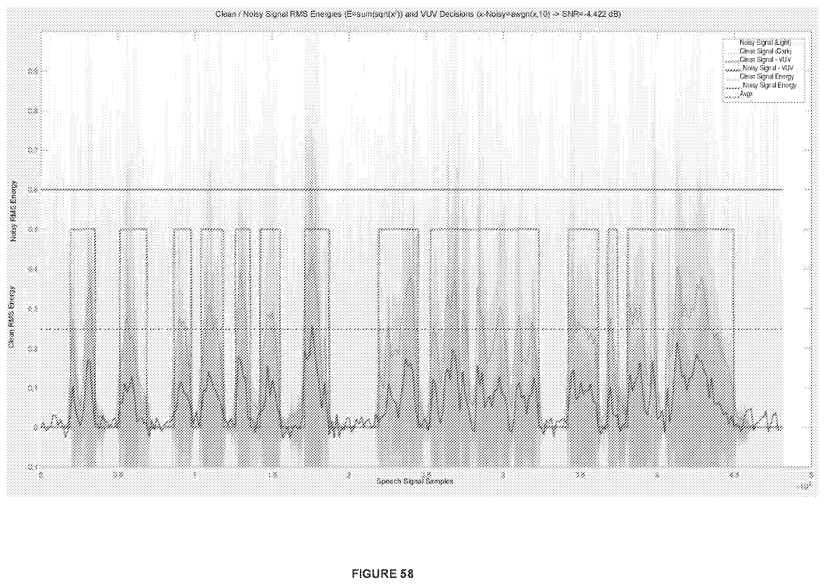

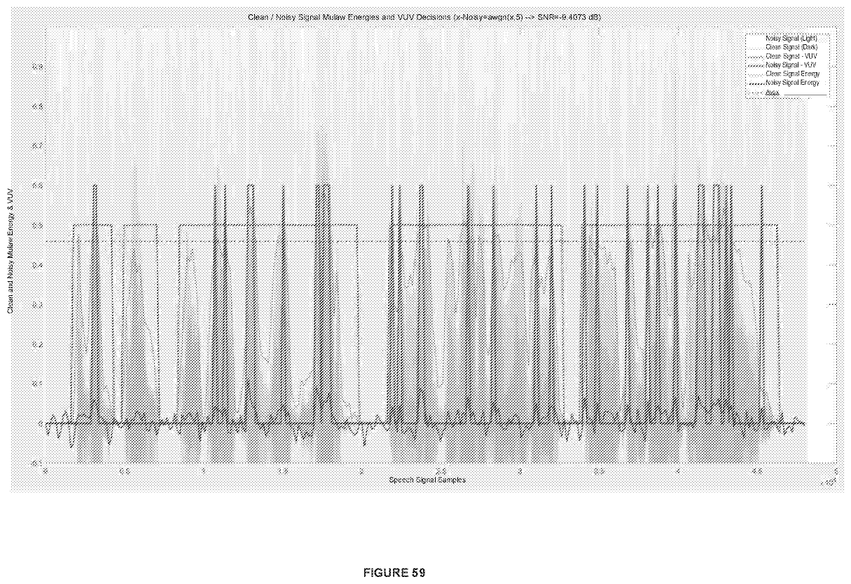

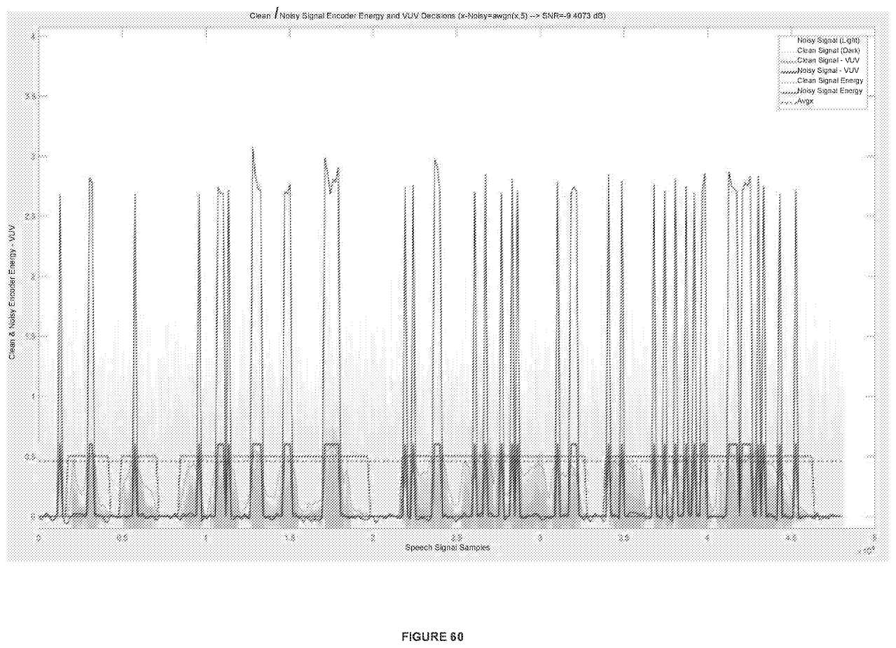

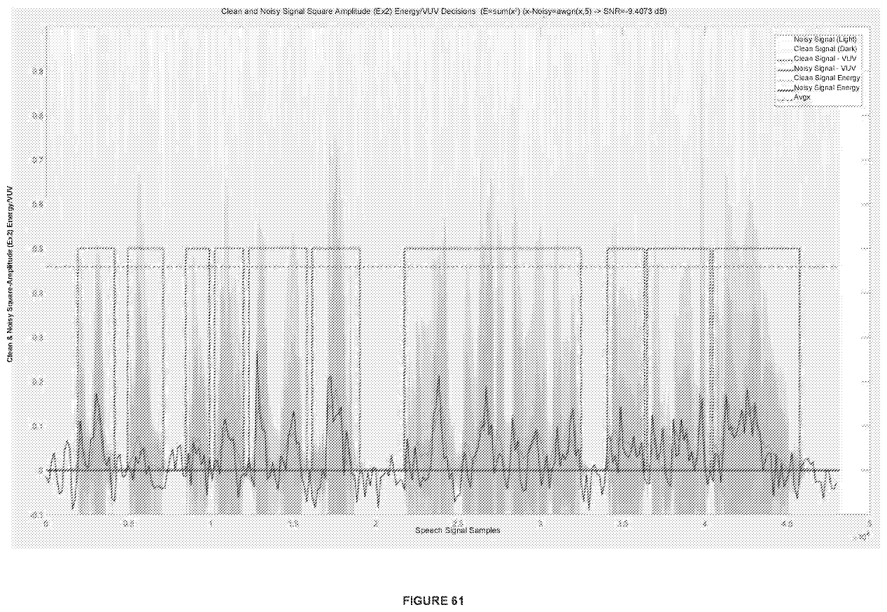

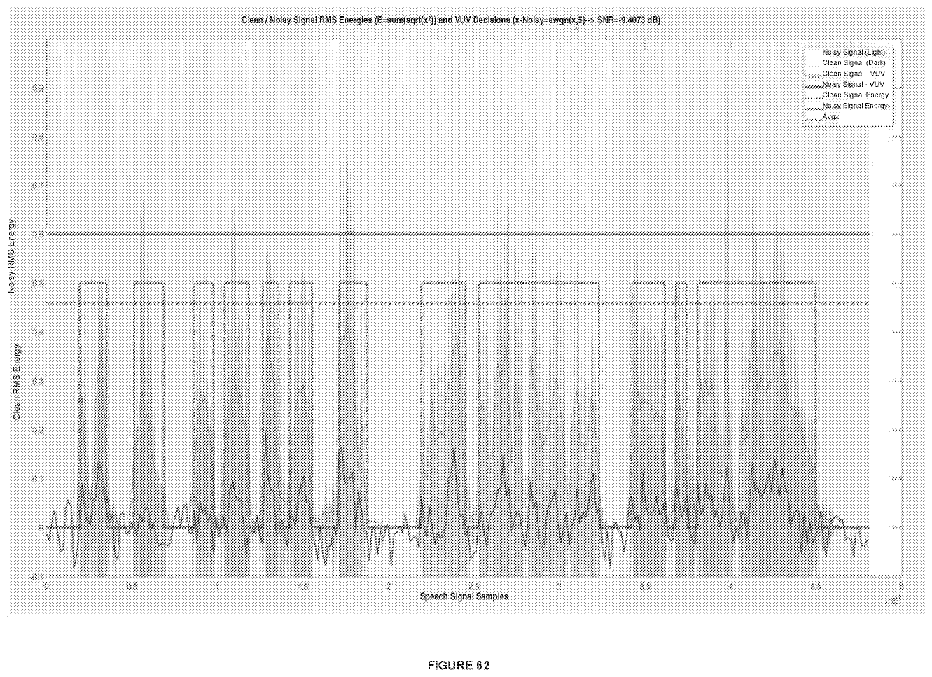

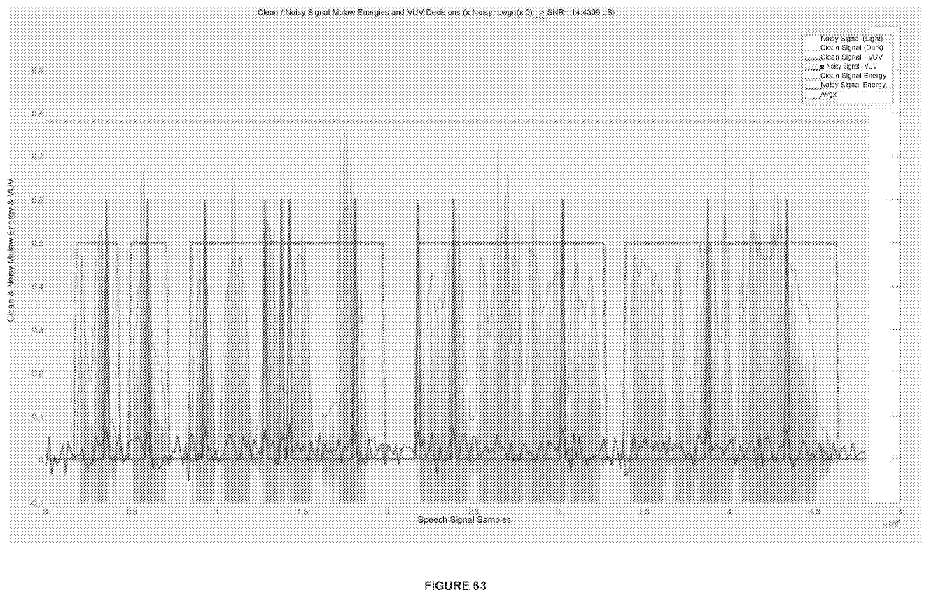

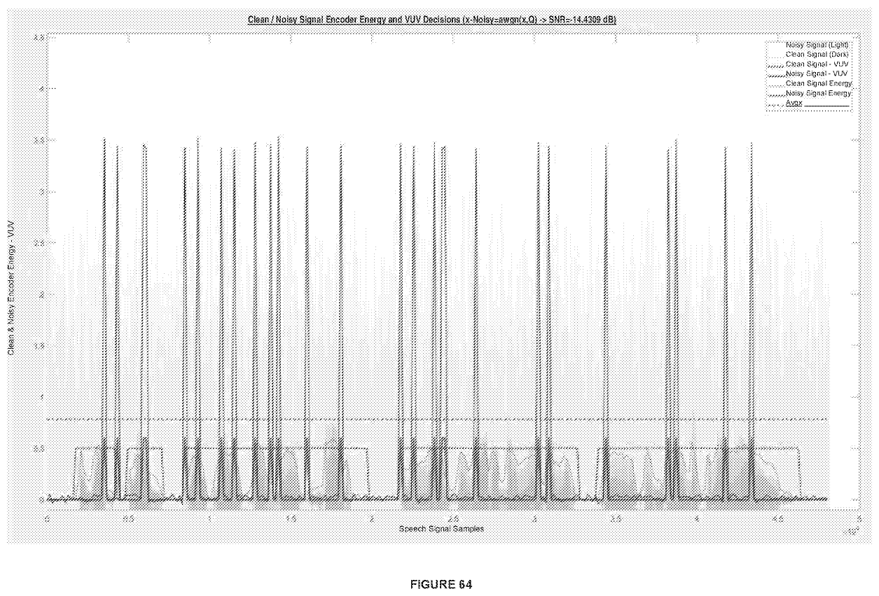

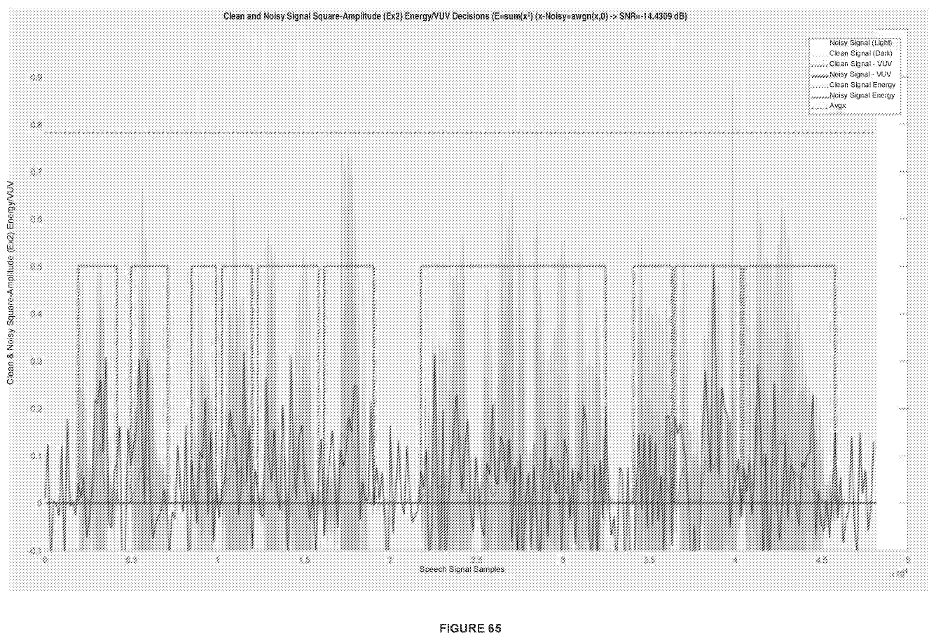

In the Energy calculation using the inventive encoder, firstly Equation 9, which was created in the scope of this study based on Equation 8 (Erms) was used and Ewrms values calculated by taking the square root of the sum of the squares (Fw(x(n))) of the input signals(x(n))transformed using Equation-2 were calculated. Respective test results indicated that the energy of small-amplitude signals in RMS (root mean square) energy calculations of normalized amplitudes is higher relative to the energy of high-amplitude signals. This increases the variance of low-amplitude signals. As the variation of signal amplitudes used in energy calculation are also logarithmically changed according to the input signal, the variance of low-amplitude signals increases when Ewrms energy calculation shown in Equation 9 is used to calculate energy, and consequently, the possibility of deviating from the threshold value increases. Therefore, for calculating the encoder energy, starting from Equation 10, Equation 12 which was created within the framework of this study, was used and EwS(n) values that perform calculations by taking the sum of squares of values (Fw(x(n)) of input signals (x(n)) transformed by using Equation 2 were calculated. Voice activity region detections performed according to energy calculations carried out with Equation 12 were observed to yield more reliable results (FIGS. 39-66). Input signal energy measuring test results in charts provided in FIGS. 15-38 were obtained for the following energy measurement methods respectively and were tested for noise signals at various SNR levels. The performance of the method was measured by considering accurate detection rates calculated by taking account of voice activity region borders of clean speech recordings.
μ-law (mulaw) Energy Calculation Method (Equation-11)
Encoder Energy Calculation Method (Equation-12)
Square-Amplitude Energy Calculation Method (Equation-10)
RMS Energy Calculation Method (Equation-8)

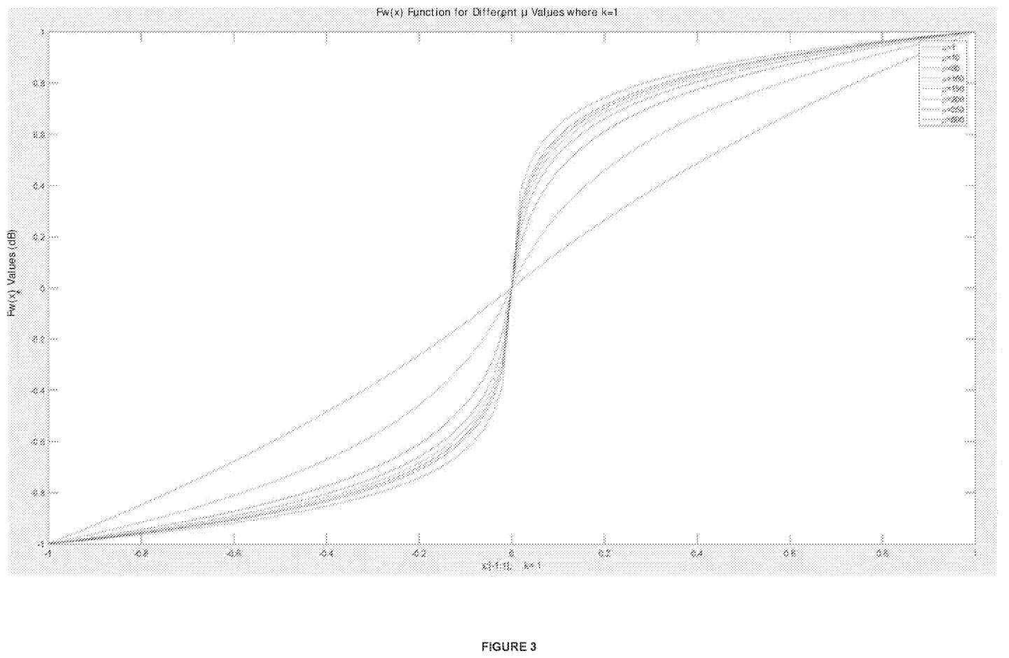

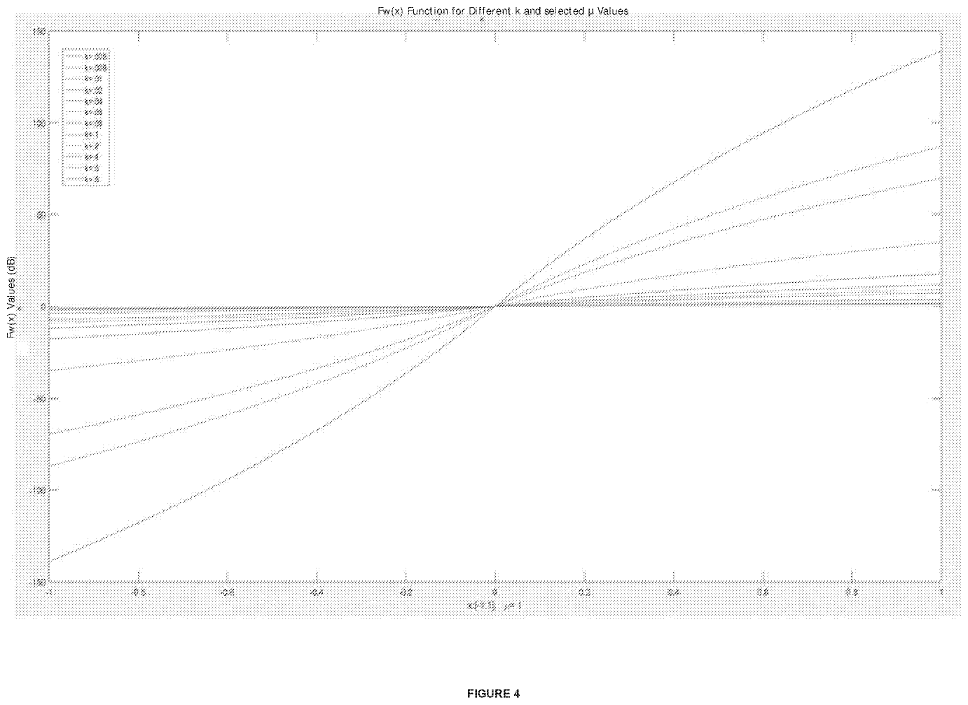

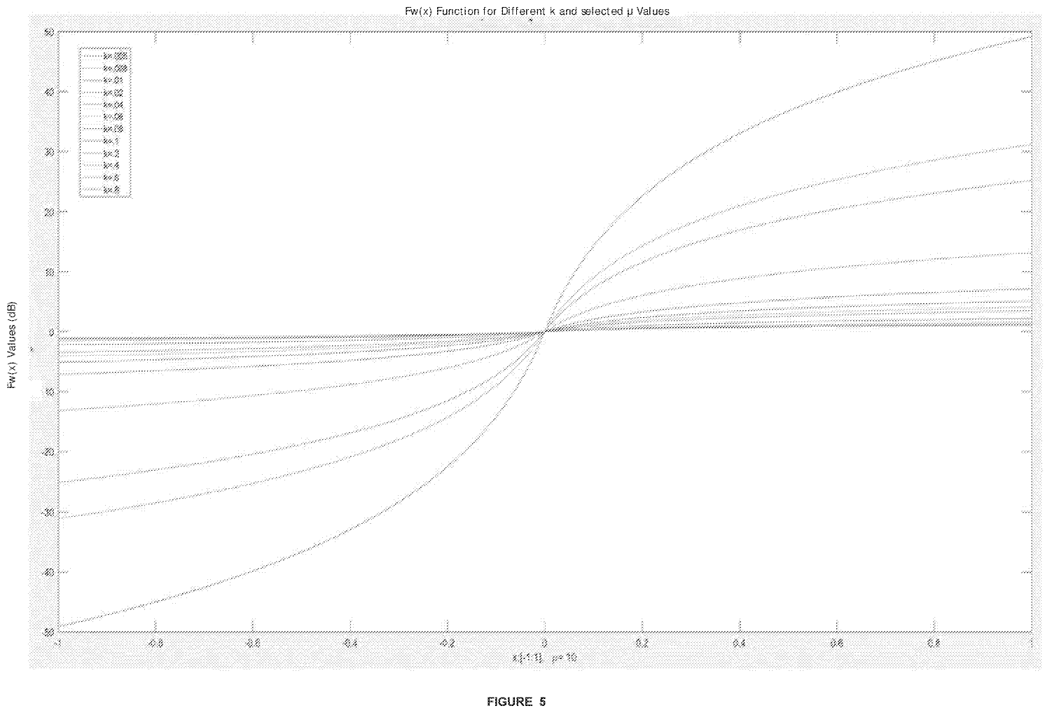

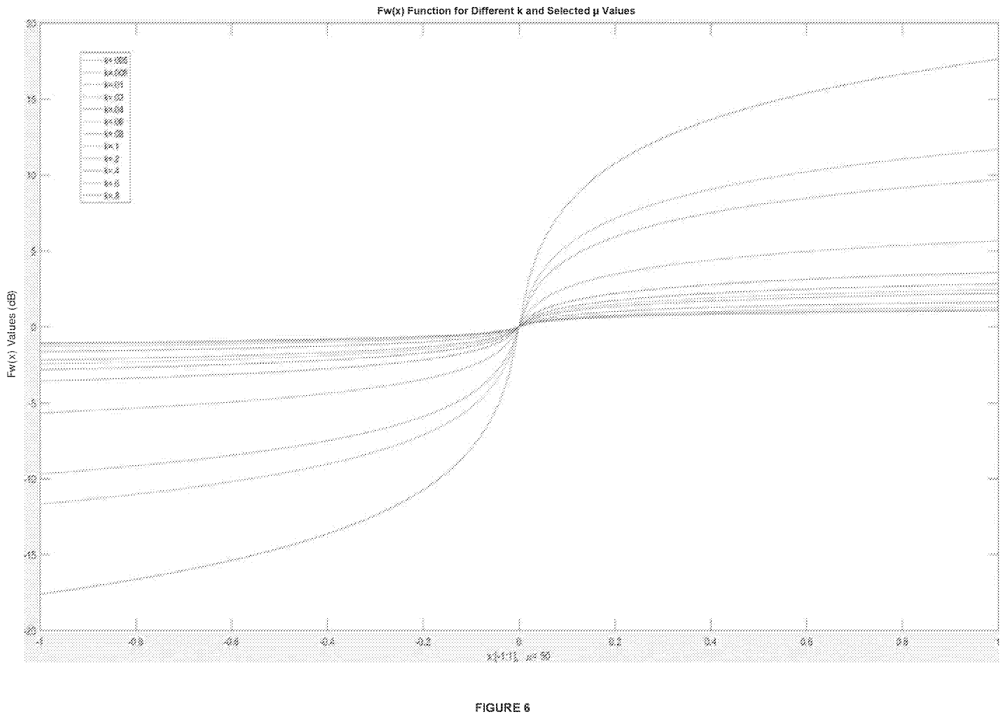

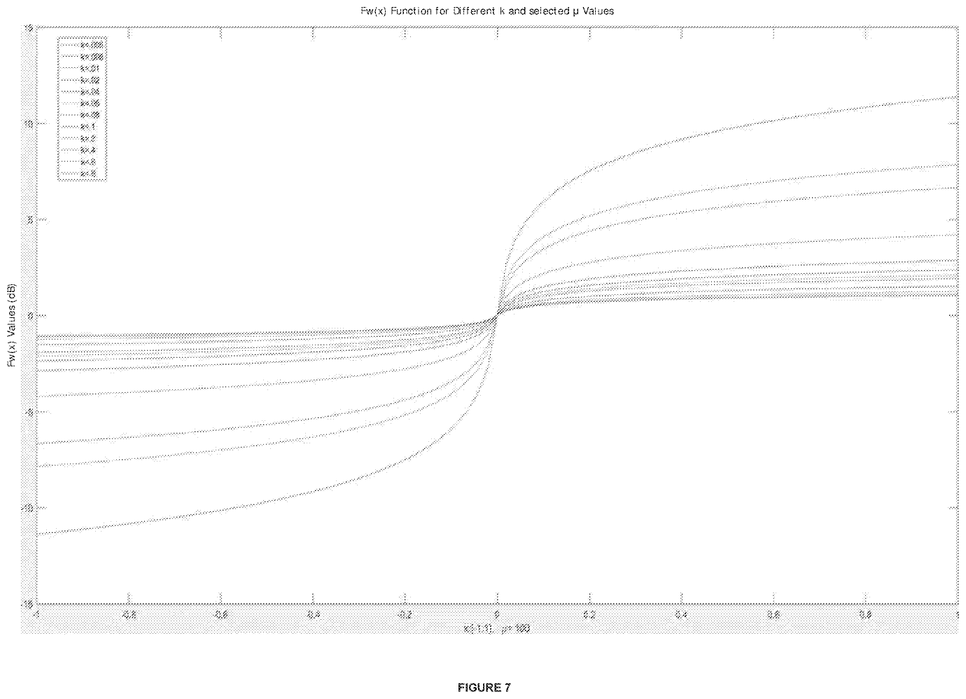

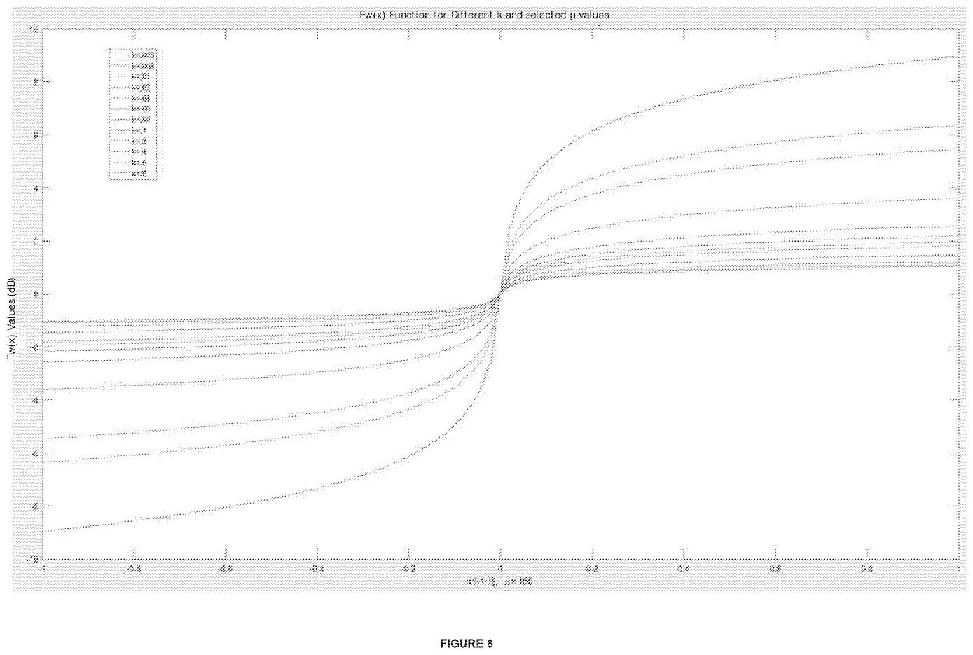

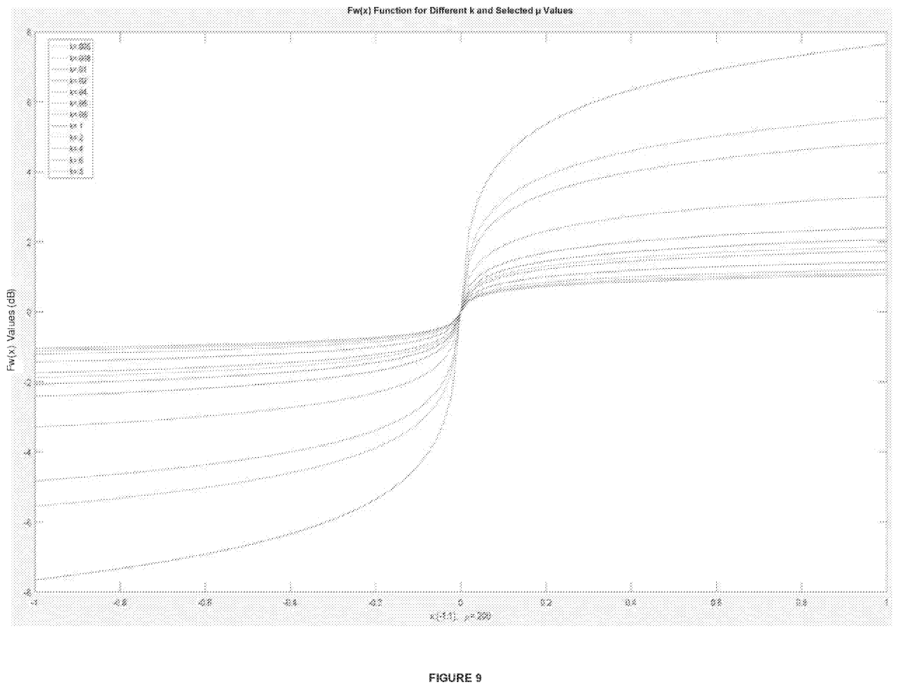

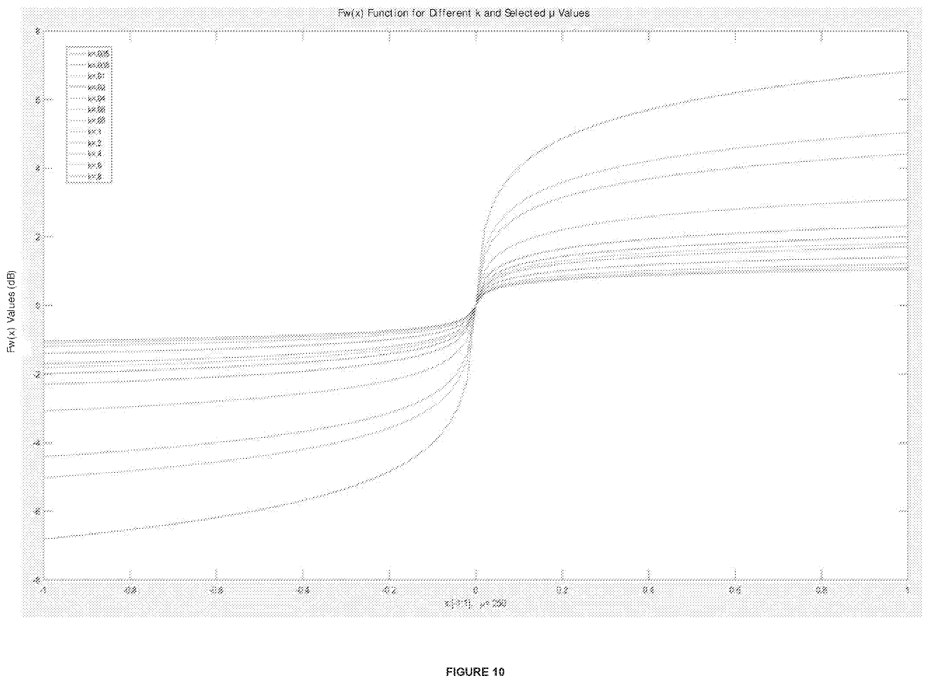

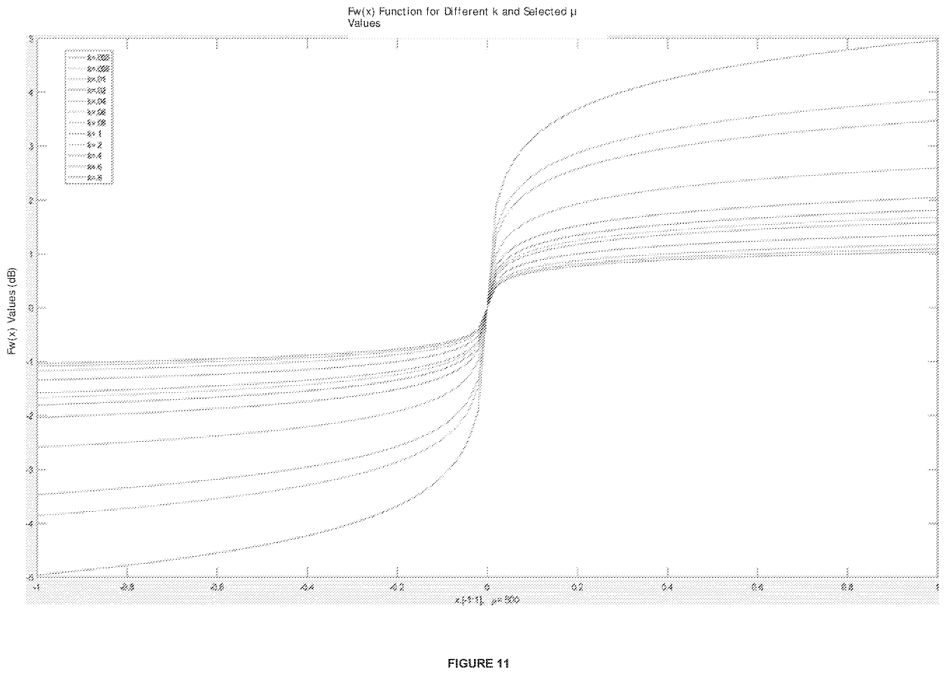

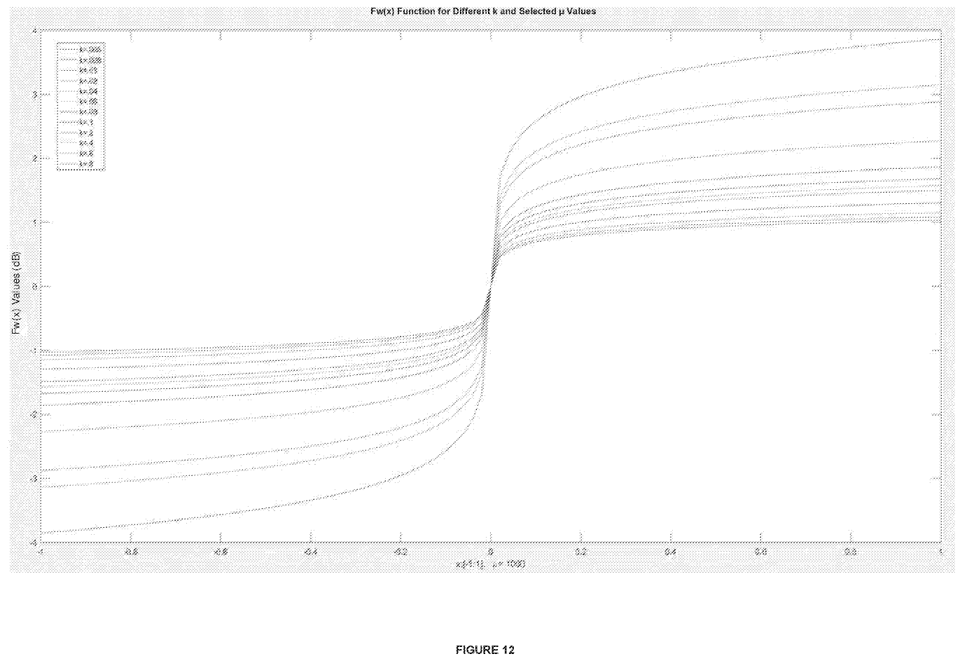

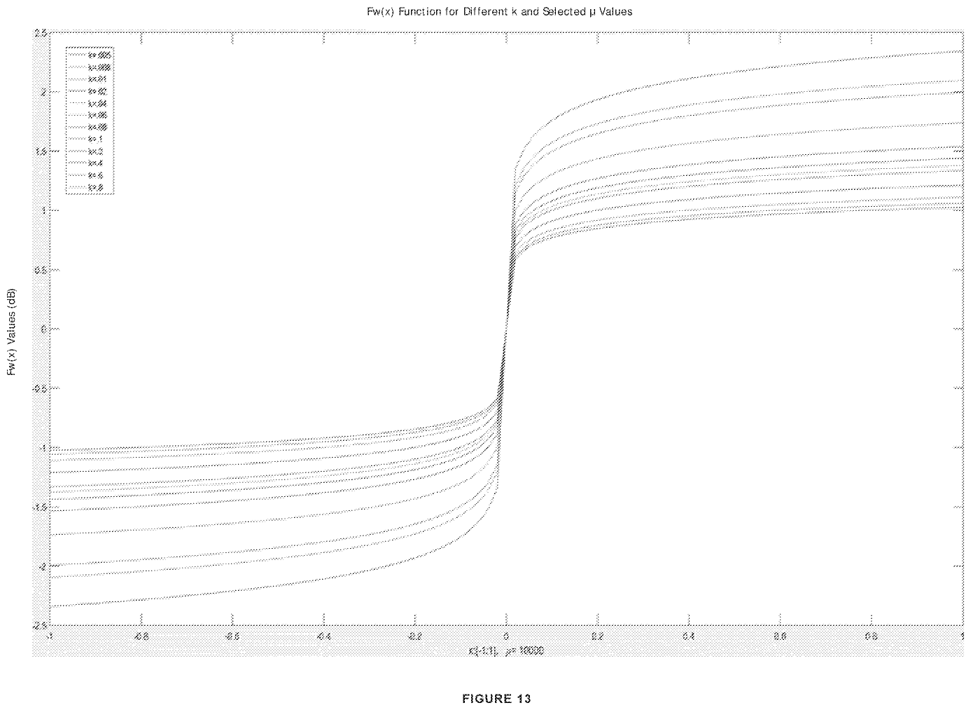

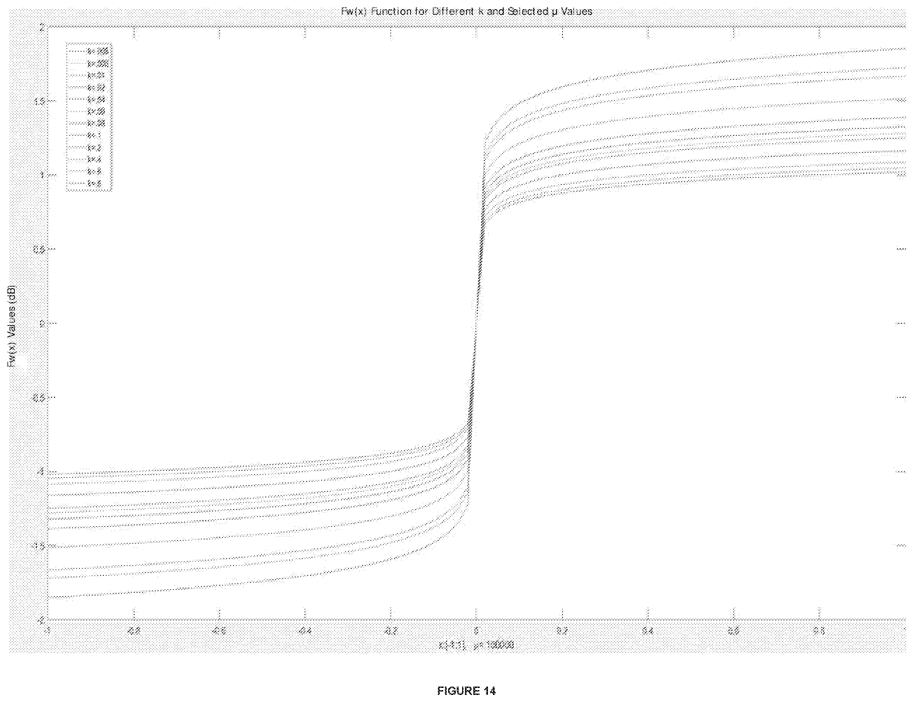

The results shown in charts illustrated in FIGS. 39-66 are the results indicating the voice activity region detection of the input signal of which energy is calculated according to energy calculations in FIGS. 3-14. The results herein show that voice activity region analyses based on the encoder energy calculation yield much better results at every noise level compared to other three methods, and voice activity regions can be detected successfully even if the SNR noise level increases by −14 dB, and faulty voice activity region detection rate remains at a minimum.

Detecting voice active regions of a speech signal is of vital importance in digital speech processing applications. Voice activity detection (VAD) methods are utilized in almost all fields of digital speech signal processing such as speech recognition, echo cancellation, VoIP (Voice Over Internet Protocol). Distinguishing voice-active regions from silent regions within the speech signal properly is very important since it will minimize the analysis durations of speech processing methods. Faulty detection of voice-active regions particularly in speech recognition methods results in a serious degradation in the output signal.

High-performing voice activity detection methods enhance the bandwidth performance in VoIP applications and allow more users to utilize the same band. Studies on voice activity detection to date conducted either in the time domain or in the frequency domain. Time-domain methods are generally based on energy calculation and zero-crossing rate (ZCR) methods. Frequency domain methods utilize spectrum information. Time-domain methods feature less computational complexity compared to frequency-domain methods, and computational simplicity and efficiency parameters are very important in voice activity detection methods. Thus, the voice activity detection method may be implemented in speech processing methods such that it does not cause any time delays. In a time-domain analysis, the amplitude of the speech signal within the analysis window is a crucial parameter for separating voice-active and silent regions from one another. If the SNR value of the input signal is high, then the lowest audio level that is above a threshold value calculated by considering the background noise may be detected by means of the energy calculation for voiced and unvoiced regions. This, however, does not allow for creating audio recording conditions with a very high SNR level in real-time practical applications. In voice-active regions, the speech signal divides into two sections as voiced/unvoiced. Signal amplitude is an important indicator for separating voiced signals from unvoiced signals. Peak amplitudes of voiced speech signals are approximately five times greater than the peak amplitudes of unvoiced speech signals and although it is possible to separate voiced signals by using the energy calculation method, separating unvoiced signals from noise is difficult because of their low amplitude. Energy calculation method implemented to date either performed by obtaining the sum of squares of signal amplitudes in the analysis window (Equation 10), or by taking the square root of the sum of squares of amplitude through the root mean square energy calculation (Equation 8). Subsequently, voiced/unvoiced (VAD) regions are distinguished from one another based on a determined threshold value. Signal energy in both methods, when there is a base noise within the analyzed signal, have difficulties in separating the noise and the signal from one another, and voiced/unvoiced decision methods require decision improvement by examining previous and future analysis windows. ZCR, being another time-domain analysis method, is based on the difference of rational value in an analysis window within voiced and unvoiced signals. If there is an unvoiced speech signal in the analysis window, then the ZCR value takes a higher value compared to the voiced speech signal. On the other hand, if there is a base noise within the speech signal, this affects ZCR value significantly both for voiced and unvoiced signals and increases the variance value, and concordantly determining a threshold value for separating voiced and unvoiced signals become quite difficult. And this complicates identifying speech boundary points in voice activity detection methods.

A speech processing system should perform efficiently in distinguishing unvoiced speech sounds of which amplitude is much lower compared to voiced speech signals, from non-speech regions. Separating unvoiced speech signals from the background noise is quite difficult for speech sounds with the background noise signal. The method proposed within the scope of the present invention allows for detecting speech signals even in cases where background noise signal levels are significantly high and for separating speech signals from the background noise, and it offers remarkably better performance compared to separation performed with normal energy calculation technique. Furthermore, the energy calculation method based on the sum of square amplitudes within the analysis window (Equation 10) offers inadequate performance particularly in separating the unvoiced speech signals from the background noise signal due to energy values approximate to the threshold value. In addition, energy value becomes smaller because the total energy is divided by the number of signals in the analysis window, thereby complicating voice activity detection based on signal energy. The energy value generated in the encoder subject to the invention follows a variation that is quite compatible with the time-domain amplitudes of the speech signal. Thus, real-time separation of voiced and unvoiced regions of the signal becomes possible by analyzing only the energy value.

The human auditory system is believed to perform logarithmic operations. High-amplitude sounds do not require resolution as high as low-amplitude sounds. In other words, identifying low amplitude sounds properly is of vital importance in order to ensure that the speech signal is understood correctly. Consequently, many different voice activity detection methods based on energy calculation in the literature require searching previous/future analysis windows in order to accurately identify the points where the speech signal starts and ends. This necessity, however, for analysis in previous/future speech windows is not compatible with real-time speech processing methods. The encoder subject to the invention performs logarithmic energy calculation which logarithmically considers the variation of signal amplitudes, instead of performing normal distribution energy calculation. Thus, the energy values of low-amplitude speech signals may be increased relatively, thereby increasing the possibility of being detected. The logarithmic scale used in the encoder subject to the invention may be increased or decreased based on the selected μ value. Voiced and unvoiced speech windows may be identified from calculated energy values with reference to the threshold value determined by considering unvoiced analysis windows at the beginning of the analysis as a result of the energy calculation of logarithmic amplitude signals that are calculated as per the proposed technique. Despite the fact that the calculation and analysis method is quite simple, it is observed that it operates quite efficiently even speech signals with very high base noise levels. The encoder subject to the invention is aimed to solve the problem of determining the real boundaries of voice-active regions in a speech signal (endpoint location problem) which is one of the major issues in speech signal processing.

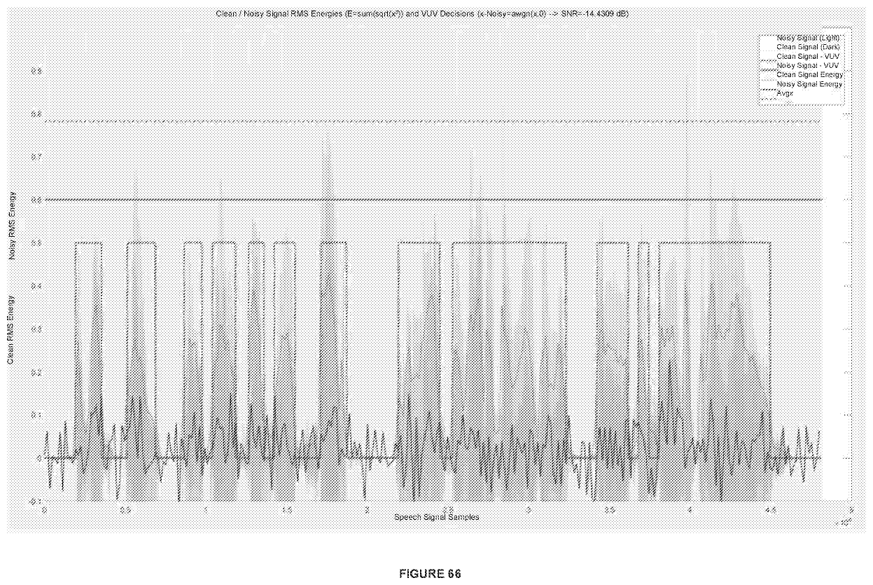

To be able to calculate energy (Equation 2 and Equation 12) by means of the encoder subject to the invention, an equation was sought through which energy signal levels may be maintained as the level of the noise signal increases. Coefficient k determined under the conditions of the experimental study conducted within the scope of the present invention was tested by considering the fact that the increment of energy values that are closer to the base noise level is less and that the increment of the energy of high-amplitudes is more, while the desired energy levels are maintained, and coefficient k was defined in (Equation 3) as a variable that is exponentially dependent on the input signal amplitudes and the minimum energy of the input signal. The ‘a’ value, as denoted herein, was determined as the difference of mean value (mean(x(n))) of signal amplitudes in the analysis window to the mean signal noise amplitude value (avgx) of speech signals in the unvoiced region at the beginning (Equation 4 and Equation 5). Eₘᵢₙ value is the average energy threshold value calculated from unvoiced windows located at the beginning of the speech signal (Equation 6). b1 and b2 values are variables with constant values. Optimal b1 and b2 values that will ensure the best performance for the input signal at various noise levels were searched by varying b1 in a range between [1-100], and b2 in a range between [0-1] for any input signal (x(n)) normalized between (−1:1). An increase of b2 value was observed to induce an increment in the value of low-amplitude signals that are near the noise level. (since selecting b2 such that it is greater than 1 creates an offset on the energy calculation, maximum value of b2 was set to 1). In the case where b1=1, a suitable value for b2 was searched. It was observed that as b2 value increases, the energy of high-amplitude signals significantly increases as well. Appropriate b1 and b2 values were searched experimentally for input noise signals SNR (signal-noise ratio) levels of which reach up to [SNR: −15 dB] to be able to detect VAD regions. b1 was given the value 50 and b2 was given the value 0.1 considering that these values provide the optimal results among the selected values and respective tests for (k=e^{-(50·\sqrt{a}+0.1)·Emin)}) were carried out. All test results are illustrated in charts given in FIGS. 3-66. In the experimental studies carried out with formula k, its effects on energy calculation performed with the encoder subject to the invention were tested on clean and noisy audio signals and excellent results were obtained in both signals. Energy calculations performed by the u-law technique and by the encoder subject to the invention methods yield similar results for sounds with low noise levels. In contrast thereof, the encoder subject to the invention method is particularly effective in calculating energy values in noisy signals. In the encoder subject to the invention method, on the other hand, since the ‘k’ value that decreases as the noise level increases, causes a significant increment in low-energy signals that are close to the noise level, the variance of energy amplitudes increases when non-speech unvoiced regions of sounds with a very high noise level are calculated by means of the encoder method by preserving the k value. Said variance increasing in energy amplitudes at unvoiced regions that do not comprise speech may be decreased by means of energy amplitude values recalculated by selecting k=1 condition in regions that are below the energy threshold value by increasing the number of analysis windows as disclosed above.

$$Esikdgr = \{ \begin{matrix}( 1 + {e}^{- c * avgx} ) * Thre & if 0.01 < avgx < \text{.99} \\ 4 * Thre & if avgx < 0.01\end{matrix} , c : constant value \qquad ( 13 )$$

Several tests have been carried out with noise signals at different SNR levels added on the clean speech signal in order to evaluate the encoder of the invention. Respective test results are illustrated in charts shown in FIGS. 3-14. Test results indicated that energies calculated with conventional energy calculations such as Equation 8 and Equation 10 were below the noise threshold value to a large extent, while encoder subject to the invention energy method (Equation 12) displayed an excellent performance with values that were above the noise threshold level. Energy calculations performed with Equation 8 and Equation 10 indicates that signal energy value substantially remains below the threshold value of the noise signal thereby raising difficulties for separating the original signal from noise based on energy calculation.

It should be noted that the main object of the encoder subject to the invention and method is to obtain an energy calculation that is minimally affected by the increasing number of variances and through which maximum average energy levels are maintained for various input noise signal levels, and that is capable of getting good results in the VAD method thereby, and it was observed that good results may be obtained when the aforementioned method is selected for the coefficient k value and that there was no need for searching for other b1 and b2 values via more precise measurements in order to preserve the highest energy level. Constant values for b1 and b2 through which the optimal energy level is preserved may be searched via more precise measurements when required.

The flow chart provided in FIG. 1 and FIG. 2 illustrate the flow chart of the VAD method performed by means of the energy calculation of the encoder subject to the invention. Noisy input signals were generated by adding random noise signals at various SNR levels to the input speech signal for the purpose of measuring the efficiency of the inventive method, and the efficiency of the inventive method was tested on these noisy signals. It was observed that the inventive method substantially maintains its efficiency even in noisy signals.

VAD method of the encoder subject to the invention is as follows; threshold values in Equation 6 and Equation 7 were subsequently utilized for separating voiced/unvoiced speech windows (VAD) from one another. An energy threshold value is determined from selected analysis windows and stored to be able to perform voiced/unvoiced speech analysis. In the second stage, the speech signal in each analysis window of speech signals is transformed into a new signal by means of the encoder method, and the energy calculation is performed for the transformed signal. The calculated energy value is compared to the threshold value calculated initially and voiced/unvoiced regions are distinguished from one another. The efficiency of the proposed method in comparison to VAD algorithms developed by using the energy calculation methods shown in Equation 8 and Equation 10 and to the μ-law method shown in Equation 1 was tested for noisy speech signals at various SNR levels, and the respective tests yielded very good results. The results have shown that the proposed method's efficiency in detecting voiced/unvoiced speech regions is much higher compared to VAD algorithms based on energy methods particularly in signals with high noise levels.

If the energy value in the analysis window is greater than the predetermined threshold value in analyses performed with the inventive method, then the starting point of the speech signal is determined and marked as K1. Regions that are above the threshold value are defined as “voice-active” regions. The ending point of the speech signal is determined and marked as K2 once the calculated energy value drops below the threshold value once again. Since the implemented method does not change markings of the original input speech signal (x(n)), it also allows for including the ZCR method in the analysis for VAD analysis when desired.

Yet another capability of the encoder subject to the invention energy method is that it preserves the notation (x(n)) of the original input signal in the Fw(x(n)) signal. Thus, energy and zero-crossing rate (ZCR) analysis may be performed together on the Fw(x(n)) signal for detecting the speech region on demand. μ=200 was selected during the tests considering the performance in analysis results in FIGS. 3-14. The reason of selecting this value is that it is considered to provide optimal performance between the increase rate of small amplitudes and the dynamic variation range of high amplitudes and that it does not cause a significant increase in the signal amplitude values when the k value changes in a range of (0.005-1]. As can be understood from test results in charts illustrated in Figures [15-38], energy level detection particularly for input speech signals with high noise levels may be performed even at −14 dB of SNR level.

VAD region detection test results given in charts illustrated in FIGS. 39-66 may be summarized as follows; all energy calculation formulas are given in Equation 8, Equation 10, Equation 12 and Equation 11 were tested for detecting VAD regions. To that end,
RMS Energy Method (Equation 8)
Square-Amplitude Energy Method (Equation 10)
μ-law (mulaw) Energy Method (Equation-li)
Encoder Energy Method (Equation 12) were considered respectively.

Noisy and clean signal VAD regions and noisy and clean signal energy levels for respective methods along with the calculated average signal noise amplitude value (avgx) were plotted in an overlapping manner in all charts. Firstly, VAD regions and energy levels for clean (noise-free) audio signals were plotted as it can be seen in Item no. 1. As it is seen, VAD region decisions of all methods are somewhat identical for the clean audio signal. Furthermore, VAD regions of each method are close when the SNR value of the noisy input signal is about 15 dB as it can be seen in item no. 2. As it becomes evident from item no. 4, μ-law energy calculation rapidly decreased for the noisy signal, and VAD regions shrank quickly in parallel therewith when the SNR level dropped to approximately 0 dB. The encoder subject to the invention, however, continues detecting VAD regions in a broad range. Encoder energy regions maintain their high amplitude. VAD analyses performed according to Equation 8 and Equation 10 lose their detection capabilities when the SNR value of the noisy input signal is around 0 dB or below. Despite the fact that the μ-law method shown in Equation 11 appears to maintain detection capabilities thereof, it fails to provide reliable results due to rapidly dwindling energy regions below 0 dB SNR and increasing variance amount. The encoder subject to the invention energy method, on the other hand, continues detecting the energy regions of signals amplitude values of which are above the noise signal even around SNR−14 dB.

1. (canceled)

2. A method for detecting speech activity regions of the encoder used for detecting speech activity regions, characterized by comprising following process steps;
Receiving the speech signal (100) from the encoder,
Dividing the speech signal to analysis windows by means of the speech signal window divider (101),
Determining Initial values Eₘᵢₙ, μ, and threoffset by means of the Initial value determiner (102),
Calculating the average signal-to-noise amplitude value (Avgx) with the energy average value calculator (103) by using the equations of
$$a = ( \frac{1}{N} {\sum }_{n = i \cdot N}^{i \cdot N + N - 1} \vert x ( n ) \vert - avgx ) ,$$
$$avgx = \frac{1}{f \cdot N} {\sum }_{n = 1}^{f \cdot N - 1} \vert x ( n ) \vert ,$$
Calculating the energy threshold value (Thre) with the energy average value calculator (103) by using the equation of
Thre=max(Eᵢ), i=1, . . . ,f
Calculating the Esikdgr value with the energy average value calculator (103) by using the equation of
$$Esikdgr = \{ \begin{matrix}( 1 + {e}^{- c * avgx} ) * Thre & eger 0.01 < avgx < \text{.99} \\ 4 * Thre & eger avgx < 0.01\end{matrix}$$
Calculating the energy values in the unvoiced signal window range by using the average signal noise amplitude value (Avgx), energy threshold value (Thre), and Esikdgr value by means of the energy average value calculator (103),
Initiating the loop for analysis windows by means of the loop initiator (104),
Obtaining the ews(n) value by the analysis window energy calculator (105) by using the equation of
$$EwS ( m ) = ( \frac{1}{N} ) {\sum }_{n = m \cdot N}^{m \cdot N + N - 1} {Fw ( x ( n ) )}^{\hat{}} 2$$
Calculating the energy value with the analysis window energy calculator (105) by using the equation of
Fw(x(n))=sgn(x)·ln(1+μ·|x(n)|)/ln(1+k·μ), −1≤x(n)≤1,
Calculating the k value with the analysis window energy calculator (105) by using the equation of
k=e^{-(b1·\sqrt{a}+b2)·Emin}, b1:[1-100], b2:[0-1], −
Calculating the energy values by obtaining the sum of squares of transformed speech signal (100) values by means of the analysis window energy calculator (105),
Distinguishing voiced/unvoiced regions from one another by comparing the calculated energy value with the Initial energy threshold value by means of the equality analyzer (106),
Determining the starting point of the speech signal by means of the equality analyzer (106) if the energy value is greater than the threshold value,
Determining the ending point of the speech signal by means of the equality analyzer (106) if the energy value is less than the threshold value,
Determining and marking the starting point of the speech signal by means of the voiced region determiner (107) if the calculated energy value is greater than the threshold value,
Recording regions that are above the threshold value as the speech active regions,
Determining and marking the ending point of the signal by means of the unvoiced region determiner (108) once the calculated energy value drops below the threshold value,
Transmitting said markings to the region plotter (110) and resuming the loop after marking operations by means of the loop continuator (109),
Detecting speech activity regions for the entire speech signal by utilizing the points that are determined by the equality analyzer (106) and marked by voiced region determiner (107) and unvoiced region determiner (108) by means of the region plotter (110).

3. A method for detecting speech activity regions according to claim 2, characterized in that energy value calculation process performed by the analysis window energy calculator (105) comprises following process steps;
determining the calculated average signal noise amplitude value (avgx), compression parameter (μ), normalized input audio signal sequence (x(n)) within the analysis window and average energy signal threshold value (Eₘᵢₙ) (201),
determining b1, b2 and k_{threshold} values (202),
calculating value a (203),
calculating coefficient k (204),
making equality comparison between the coefficient k and k_{threshold} value (205),
equalizing the coefficient k to k_{threshold} value if the calculation result shows that the coefficient k is smaller than the k_{threshold} value (206),
calculating the transformed Input signal Fw(x(n)) If the calculation result shows that the coefficient k is greater than the k_{threshold} value (207),
calculating the EwS(n) energy value subsequent to respective equalization and calculation operations (208).

4. (canceled)

5. (canceled)

6. (canceled)

7. (canceled)

8. (canceled)

9. (canceled)

10. (canceled)
